(19) United States
(12) Patent Application Publication
(10) Pub. No.: US 2026/0231868 A1
(43) Pub. Date: Aug. 13, 2026

(54) Manual Tip Setters And Tip Setting Systems For Installing Injection Tools To Plant Parts

(71) Applicant: INVAIO SCIENCES INTERNATIONAL GMBH, Basel (CH)

(72) Inventors: Thomas GERSTER, Zwingen (CH); Beat MÜLLER, Olsberg (CH); Jason MIZGORSKI, Gibsonia, PA (US)

(21) Appl. No.: 19/161,186

(22) PCT Filed: Mar. 1, 2024
(86) PCT No.: PCT/EP2024/055338

§ 371 Date: Aug. 29, 2025

Related U.S. Application Data
(60) Provisional application No. 63/449,895, filed on Mar. 3, 2023.
(60) Provisional application No. 63/515,508, filed on Jul. 25, 2023.

(51) Int. Cl. A01G 7/06

(52) U.S. Cl. CPC A01G 7/06

(57) ABSTRACT

Provided are manual tip setters and manual tip setter systems comprising a manual tip setter. Manual tip setters comprise a stationary body comprising a proximal end and a distal end, a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part, and a moving body positioned at the distal end of the stationary body and comprising a leadscrew coupled to the stem portion, wherein the moving body is configured to move relative to the stationary body.

### CROSS REFERENCE TO RELATED APPLICATIONS

This application claims priority to U.S. Patent Application No. 63/449,895, filed, Mar. 3, 2023 and U.S. Patent Application No. 63/515,508, filed, Jul. 25, 2023, which are incorporated herein by reference in its entirety.

### FIELD

The present disclosure relates generally to tools and methods for administering formulations to plants, and more specifically to handheld or manual tip setters for installing injection tools or injection tips to plant parts, manual tip setting systems, and methods of using such manual tip setters.

### BACKGROUND

Plant injection has been used for administration of active ingredients to plants. Conventional plant injection approaches can involve drilling a borehole in a tree trunk and stoppering the borehole with a peg. A needle is inserted through the peg to discharge liquid into the borehole.

What are desired in the art are injection tools or injection tips that can be inserted directly to plant parts to supply active ingredients to the plant. What are also desired in the art are manual tip setters and manual tip setting systems for installing injection tools to enable safe, efficient, and controlled installation of injection tools to plant parts.

### BRIEF SUMMARY

Provided herein are manual tip setters and manual tip setting systems for installing injection systems comprising injection tools (i.e., tips) into plant parts. A power source can be applied to the manual tip setters and manual tip setting systems such as an electric drill or a pneumatic cylinder to position the manual tip setter to a plant part, install the injection tool into the plant part, and initiate the injection process.

The manual tip setters described herein are equipped with a stationary body, a hook that slides in and out of the stationary body, and a moving body that moves relative to the stationary body. The hook is configured to wrap around a plant part and form a grip around the plant part to position and stabilize the manual tip setter/tip setting system to the plant part, installing the injection tool into the plant part, and initiating the injection process when a power source is applied to the manual tip setter. Once the hook has adequately established a grip on the plant part and the tip of the injection tool has been inserted into the plant part, the moving body pushes on an active ingredient source fluidly coupled to the tip of the injection tool to activate the injection process.

In some embodiments, provided is a manual tip setter for installing a plant injection system into a plant part, the manual tip setter comprising: a stationary body comprising a proximal end and a distal end; a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part; and a moving body positioned at the distal end of the stationary body and comprising a leadscrew coupled to the stem portion, wherein the moving body is configured to move relative to the stationary body.

In some embodiments of the manual tip setter, the manual tip setter is configured to receive aa plant injection system comprising an active ingredient supply coupled to an injection tool.

In some embodiments of the manual tip setter, the stem portion of the hook is configured to slide in and out of the stationary body depending on a rotation direction of the spindle.

In some embodiments of the manual tip setter, the spindle is configured to receive a power source at the distal end of the stationary body, and when the power source is coupled to the spindle and in an operating mode, the spindle rotates in a first direction such that the stem portion of the hook slides into the stationary body, pulling the hooked portion of the hook closer to the stationary body.

In some embodiments of the manual tip setter, when motion of the spindle causes the hooked portion to hook around a plant part, a force of the leadscrew surpasses a force of one or more springs such that the hook stops sliding relative to the stationary body and the injection tool is installed into the plant part.

In some embodiments of the manual tip setter, when the force of the leadscrew surpasses the force of the one or more springs such that the hook stops sliding relative to the stationary body and the injection tool is installed into the plant part, the power source in operating mode causes the moving body to move towards the stationary body, pushing the active ingredient supply towards the plant part to initiate an injection process.

In some embodiments of the manual tip setter, once the injection tool is installed into the plant part, the manual tip setter is configured to be removed from the pant injection system by rotating the spindle in a second direction.

In some embodiments of the manual tip setter, the power source comprises an electric drill.

In some embodiments of the manual tip setter, the power source comprises a pneumatic cylinder.

In some embodiments, a manual tip setting system for installing a plant injection system into a plant part, the system comprising: a plant injection system; and a manual tip setter comprising: a stationary body comprising a proximal end and a distal end; a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part; and a moving body positioned at the distal end of the stationary body and comprising a leadscrew coupled to the stem portion, wherein the moving body is configured to move relative to the stationary body.

In some embodiments of the manual tip setting system, the manual tip setter is configured to receive the plant injection system comprising an active ingredient supply coupled to an injection tool.

In some embodiments of the manual tip setting system, the stem portion of the hook is configured to slide in and out of the stationary body depending on a rotation direction of the spindle.

In some embodiments of the manual tip setting system, the spindle is configured to receive a power source at the distal end of the stationary body, and when the power source is coupled to the spindle and in an operating mode, the spindle rotates in a first direction such that the stem portion of the hook slides into the stationary body, pulling the hooked portion of the hook closer to the stationary body.

In some embodiments of the manual tip setting system, when motion of the spindle causes the hooked portion to hook around a plant part, a force of the leadscrew surpasses a force of one or more springs such that the hook stops sliding relative to the stationary body and the injection tool is installed into the plant part.

In some embodiments of the manual tip setting system, when the force of the leadscrew surpasses the force of the one or more springs such that the hook stops sliding relative to the stationary body and the injection tool is installed into the plant part, the power source in operating mode causes the moving body to move towards the stationary body, pushing the active ingredient supply towards the plant part to initiate an injection process.

In some embodiments of the manual tip setting system, once the injection tool is installed into the plant part, the manual tip setter is configured to be removed from the plant injection system by rotating the spindle in a second direction.

In some embodiments of the manual tip setting system, the power source comprises an electric drill.

In some embodiments of the manual tip setting system, the power source comprises a pneumatic cylinder.

In some embodiments of the manual tip setting system, the active ingredient supply comprises a pressurized spray can.

In some embodiments, a method is provided for installing a plant injection system into a plant using any one of the above manual tip setters or manual tip setting systems, the method comprising: advancing the plant injection system to the plant part by moving the hooked portion, wrapped around the pant part, towards the stationary body of the manual tip setter; installing, via the manual tip setter, the injection tool into the plant part; and initiating, by forcing the moving body towards the stationary body, the injection process.

In some embodiments of the method, advancing the plant injection system to the plant part by moving the hooked portion, wrapped around the pant part, towards the stationary body of the manual tip setter further comprises applying a power source to a power source port located at the moving body.

In some embodiments of the method, initiating, by forcing the moving body towards the stationary body, the injection process, occurs when the force of the leadscrew surpasses the force of the one or more springs and causes the moving body to move towards the stationary body, pushing the active ingredient supply towards the plant part to initiate an injection process.

### DESCRIPTION OF THE FIGURES

The present application can be understood by reference to the following description taken in conjunction with the accompanying figures.

FIG. 1 shows a perspective view of a manual tip setter, according to some embodiments;

FIG. 2A shows a perspective view of a manual tip setting system, according to some embodiments;

FIG. 2B shows a perspective view of a manual tip setting system, according to some embodiments;

FIG. 3 shows a top view of a manual tip setting system, according to some embodiments;

FIG. 4 shows a n exploded view of a manual tip setter, according to some embodiments;

FIG. 5A shows a manual tip setting system that is not installed in to a plant part, according to some embodiments;

FIG. 5B shows a manual tip setting system in which the tip of the injection tool is installed into the plant part, according to some embodiments;

FIG. 5C shows a manual tip setting system initiating the injection process, according to some embodiments;

FIG. 6 depicts an exemplary actuator.

FIG. 7A-7C are cross-sections of an exemplary actuator mounted to a fluid delivery device.

FIGS. 8A-8C depict an exemplary process to install an injection tool and fluid delivery device connected by the exemplary actuators described herein onto the stem or trunk of a plant.

FIGS. 9A-9C depict different views of an exemplary injection tool suitable for use with the actuators described herein.

FIGS. 9D-9F are cross sections of the injection tool of FIG. 9A-9C mounted to an exemplary actuator that is mounted to an exemplary fluid delivery device.

FIGS. 10A and 10B depict an exemplary system of an injection tool positioned in an exemplary actuator connected to a canister with a bag-on-valve insert.

FIG. 11A depicts an exemplary injection tool inserted into the exemplary actuator.

FIG. 11B depicts an exemplary injection tool inserted into the exemplary actuator connected to with a canister with a bag-on-valve insert.

FIG. 12 depicts another exemplary system of an injection tool positioned in another exemplary actuator connected to a fluid delivery device.

FIG. 13 depicts the mounting of an exemplary injection tool to an exemplary actuator.

FIGS. 14A and 14B are cross-sections exemplary blade portions of exemplary injection tools.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

Provided herein are manual tip setters and manual tip setting systems for installing an injection tool into a plant part. As described in detail herein, the manual tip setters include a stationary body, a moving body, and a hook. The hook is configured to slide in and out of the stationary body along a plurality of bearings when attached to a power source such that the hook wraps around a plant part to grip the plant part and stabilize the manual tip setter to the plant part. The power source is coupled to one end of a spindle that is connected, at the other end, to the hook. When the power source causes rotation of the spindle, the hook closes in on the plant part to which it is positioned to form a grip on the plant part, or away from the plant part to loosen a grip on the plant part, depending on the direction of rotation of the spindle. In some embodiments, the tip of the injection tool is installed into the plant when the hook of the manual tip setter forms a grip around the plant part. At this point, once the injection tool (or tip) is installed into the plant part, the moving body moves relative to the stationary body, forcing an active ingredient supply (e.g., pressurized spray can) towards the installed tip to initiate the injection process.

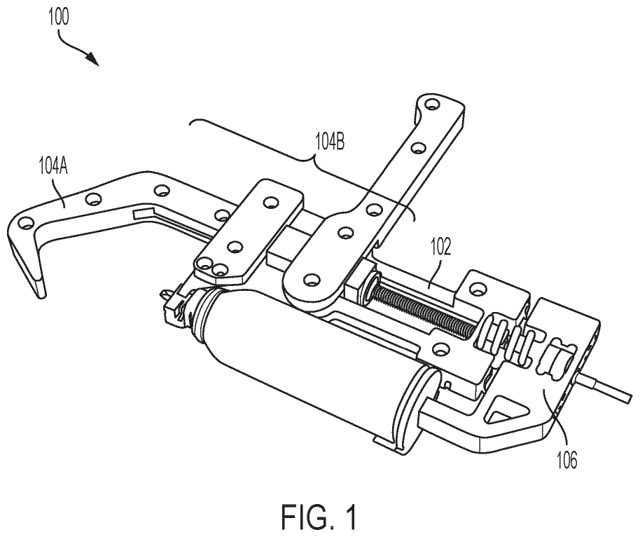

FIG. 1 shows a perspective view of a manual tip setter 100, according to some embodiments. Manual tip setter 100 includes stationary body 102, a hook comprising a hooked portion 104A and a stem portion 104B, and moving body 106.

The stationary body 102 receives a stem portion 104B of the hook such that the stem portion 104B is configured to slide within the stationary body 104B along a plurality of bearings. This sliding motion can allow hooked portion 104A to close in on and grip around a plant part, or release a grip on a plant part. When a grip is formed by the hooked portion 104A on a plant part, the installation of the injection tool into the plant part can take place. Specifically, when the hooked portion 104A forms a grip around a plant part, the tip or injection tool penetrates the plant part. After the tip or injection tool is installed, the moving body 106 can be pushed towards the stationary body 102, initiating the injection process. The mechanism by which the manual tip setter operates is discussed in further detail below.

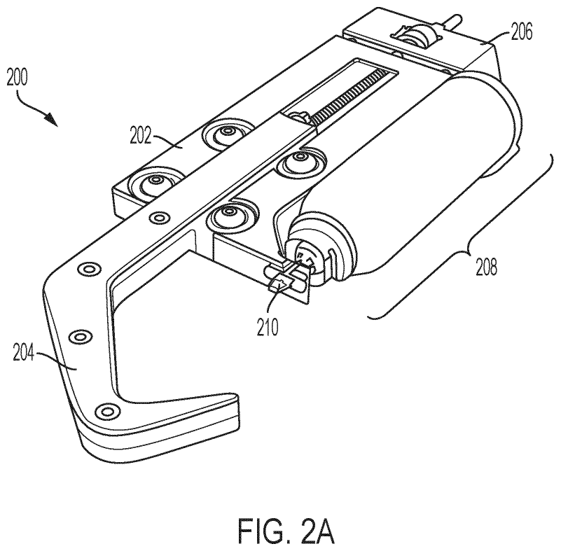

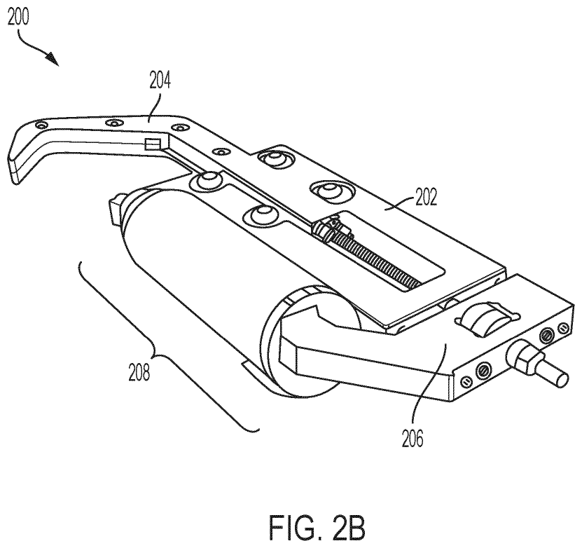

FIG. 2A shows a perspective view of a manual tip setting system 200, according to some embodiments, and FIG. 2B shows a perspective view of a manual tip setting system 200, according to some embodiments. Manual tip setting system 200 comprises a manual tip setter comprising stationary body 202, a hook 204, a moving body 206, as well as a plant injection system comprising an injection tool 210 coupled to an active ingredient supply 208 that has been loaded into the manual tip setter. In some embodiments, the plant injection system also includes an actuator coupling the injection tool 210 to the active ingredient supply.

FIGS. 2A and 2B show the plant injection system comprising the injection tool 210 coupled to an active ingredient supply 208. As described above with reference to manual tip setter 100 of FIG. 1, when the hooked portion of hook 204 closes in on a plant part and is tightly wrapped around the plant part such that the stem portion of the hook 204 cannot slide down into the stationary body 202 any further, the tip of injection tool 210 is inserted or installed into the plant part. A power source coupled to the moving body 206 end of the manual tip setting system 200 will, at this point (i.e., once the tip is installed in the plant part) force the active ingredient supply 208 towards the plant part and the tip of the injection tool 210, initiating the injection process via the actuator of the plant injection system.

In some embodiments, the active ingredient supply 208 may be a spray can. In some embodiments, the active ingredient supply 208 may be a pressurized spray can.

Once the tip of the injection tool 210 has been installed into the plant part and the injection process has begun, the grip on the plant part by the hook 204 of the manual tip setter can be released and the manual tip setter removed from the plant part, leaving the injection tool 210 installed and the active ingredient supply 208 coupled to the injection tool 210 in the plant part. This allows the plant part to receive a regular dose of the active ingredient over a period of time, until the injection tool 210 and/or the active ingredient supply 208 and actuator are removed from the plant part.

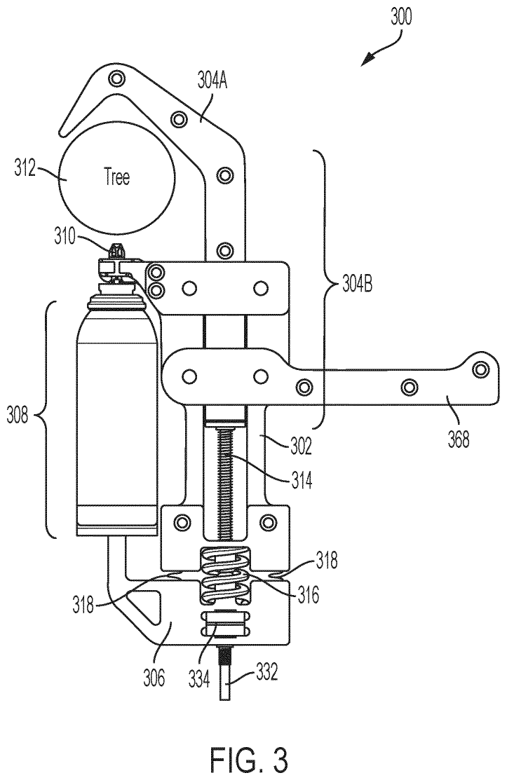

FIG. 3 shows a top view of a manual tip setting system 300, according to some embodiments. Specifically, FIG. 3 shows a manual tip setting system 300 applied or placed around a plant part 312. Manual tip setting system 300 includes stationary body 302 comprising handle 368, stem portion 304B of a hook, hooked portion 304A of a hook, moving body 306, injection tool 310, and active ingredient supply 308. Also shown are power source port 332, leadscrew 334, adjusting springs 318, main spring 316, and spindle 314.

Power source port 332 is configured to receive a power source to control the manual tip setting system 300. For example, the power source may include an electric drill or a pneumatic cartridge. When the power source is attached to the power source port 332 and in an operating mode, it causes spindle 314 to rotate. The rotation of spindle 314 causes the stem portion 304B of the hook to either slide out of the stationary body 302 or further into the stationary body 302, depending on the direction of rotation.

If the stem portion 304B slides further into the stationary body 302 to cause the hooked portion 304A of the hook to form a grip around the plant part 312, the power source continues to act on the spindle 314 and the hook until a force of the leadscrew 330 surpasses a force of the main spring 316 and the adjusting springs 318, causing the stem portion 304B of the hook to stop sliding relative to the stationary body 302 and become rigid with the stationary body 302. In some embodiments, the injection tool 310 is installed into the plant part 312 when the force of the leadscrew 330 surpasses a force of the main spring 316 and the adjusting springs 318. At this point, the power source in operating mode causes the moving body 306 to move towards the stationary body 302 and push the active ingredient supply 308 towards the plant part to initiate the injection process via the actuator of the plant injection system.

Although the manual tip setting system 300 shows a main spring 316 and two adjusting springs 318, this is just one example of a spring configuration. In some embodiments, the manual tip setter of the manual tip setting system 300 may comprise 1-5 springs. In some embodiments, the manual tip setter may comprise less than or equal to 5, 4, 3, or 2 springs. In some embodiments, the manual tip setter may comprise greater than 1, 2, 3, or 4 springs. In some embodiments, the manual tip setter comprises a single spring. In some embodiments the manual tip setter comprises a plurality of springs. In some embodiments, the amount of additional force required to overcome the force of the one or more springs (and force the moving body 306 towards the stationary body 302) is 70-00 or 110-120 N. In some embodiments, the amount of additional force required to overcome the force of the one or more springs is less than or equal to 200, 190, 180, 170, 160, 150, 140, 130, 120, 110, 100, 90, or 80 N. In some embodiments, the amount of additional force required to overcome the force of the one or more springs greater than or equal to 70, 80, 90, 100, 110, 120, 130, 140, 150, 160, 170, 180, or 190 N.

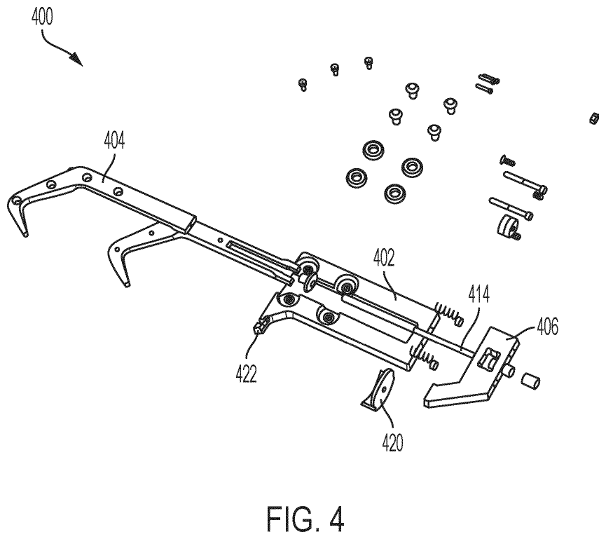

FIG. 4 shows an exploded view of a manual tip setter 400, according to some embodiments. FIG. 4 shows, among other components, stationary body 402, hook 404, moving body 406, spindle 414, seat 420, and mount 422. The seat 420 and mount 422 are configured to receive an active ingredient supply coupled to an injection tool. For example, seat 420 may be configured to receive a bottom of a spray can active ingredient supply, and mount 422 may be configured to position a tip adapter coupled to the active ingredient supply and injection tool (or tip). The seat 420 and mount 422 are configured to position and hold the active ingredient supply with tip adapter/injection tool in place and properly align the active ingredient supply with tip adapter/injection tool to a plant part for proper installation.

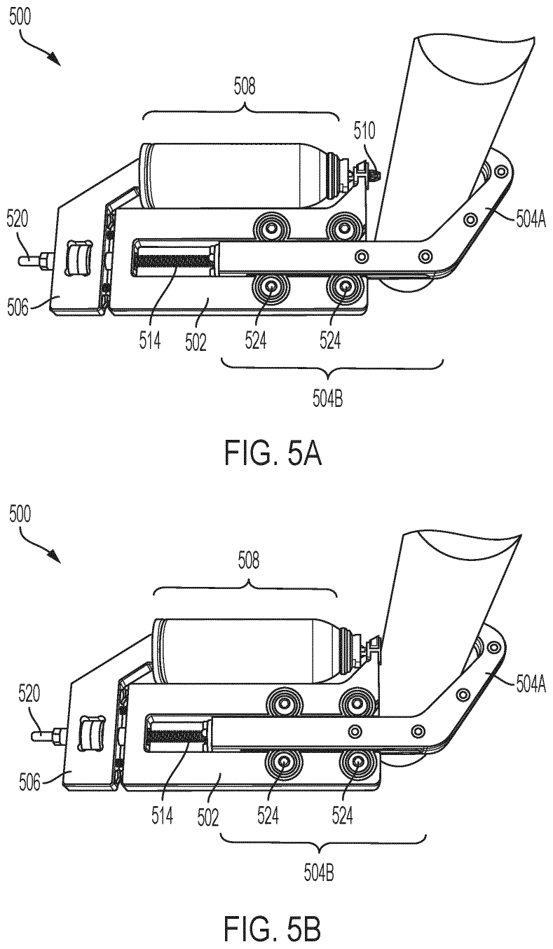

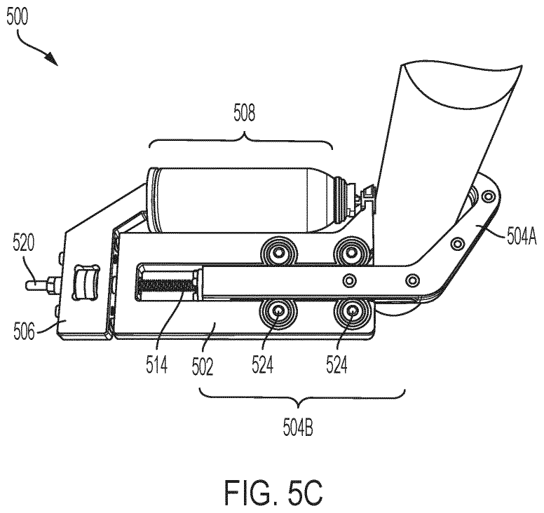

FIG. 5A shows a manual tip setting system 500 that is not installed in to a plant part, according to some embodiments, FIG. 5B shows a manual tip setting system 500 in which the tip of the injection tool is installed into the plant part, according to some embodiments, and FIG. 5C shows a manual tip setting system 500 initiating the injection process, according to some embodiments. As shown, FIGS. 5A, 5B, and 5C comprise a manual tip setter including a stationary body 502, a hook having a stem portion 504B and a hooked portion 504A, moving body 506, power source port 520, spindle 514, and bearings 524, which allow stem portion 504B to slide within the stationary body 502. The manual tip setting system 500 also includes an active ingredient supply 508 and an injection tool 510.

A shown in FIG. 5A, the manual tip setting system 500 does not have a grip or is not fully placed on the plant part. This can be shown by the space between the plant part and the injection tool 510.

However, FIG. 5B shows the manual tip setting system 500 positioned to the plant part such that the hooked portion 504A of the hook forms a grip on the plant part. This means that the injection tool 510 is installed into the plant part as well. (The injection tool or tip is not visible in FIG. 5B because it is installed into the plant part.) Once the hooked portion 504A of the hook forms a grip on the plant part and the injection tool/tip is installed into the plant part, this means that the force of the leadscrew surpasses the force of the springs (described in further detail with respect to manual tip setting system 300 of FIG. 3). Therefore, the force provided on the manual tip setter by the power source then causes the moving body 506 to move towards the stationary body 502, which causes the active ingredient supply to be forced towards the plant part, initiating the injection process. This is shown in FIG. 5C. Specifically, the moving body 506 has been pushed towards the stationary body 502 such that there is little to no space between the two components.

### Actuator

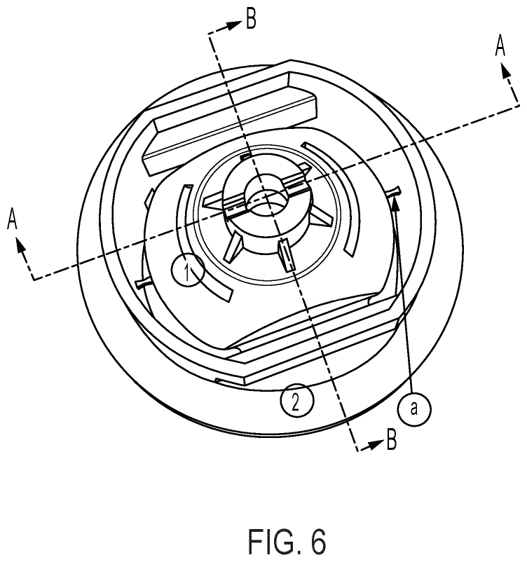

In some embodiments, the actuator comprises an activator and a frame. With reference to FIG. 6, activator (1) triggers or activates the stem of the fluid delivery device (e.g., a spraycan) by pressing on it. The activator is configured to mount the injection tool (e.g., an injection tip), which is equipped with positioning slots to ensure a precise connection between these two parts. Frame (2), as depicted in FIG. 6, contains four spreaders that press on the crimped part of the fluid delivery device and hooks itself to the crimped part. Element (a) in FIG. 6 refers to one of two predetermined breaking points on the frame that will break when the activator is pushed down. This exemplary activator may be injection molded as one part.

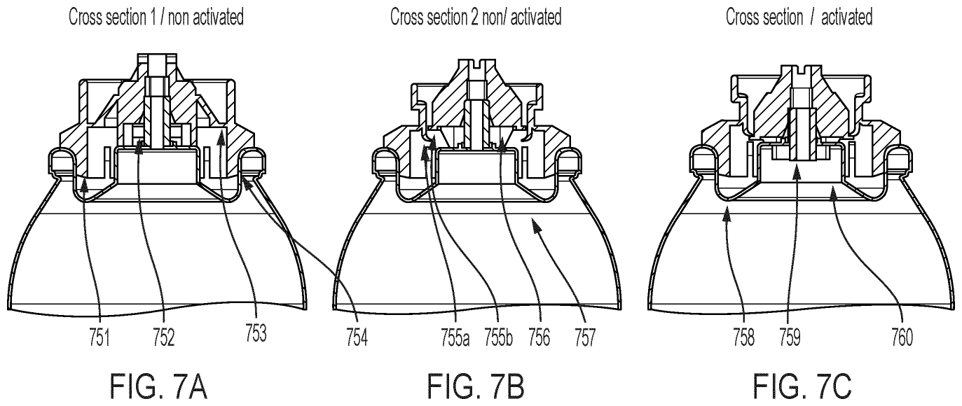

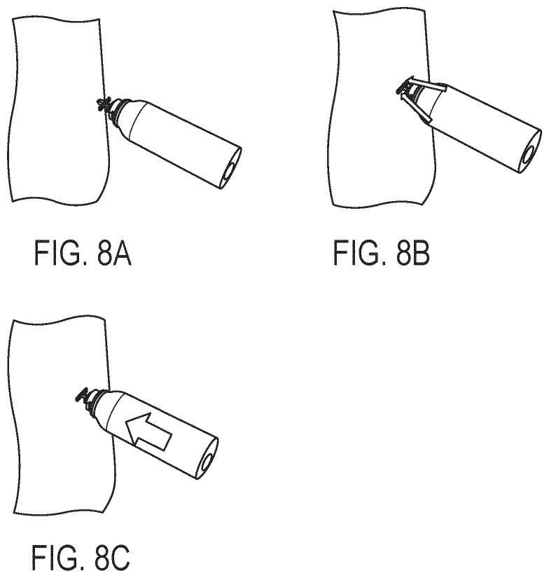

FIGS. 7A-7B are cross-sections of an example of the actuator of FIG. 6 mounted to a canister. FIGS. 7A and 7B show the actuator in a non-activated configuration, with FIG. 7A being a cross-section corresponding to line A-A of FIG. 6 and FIG. 7B being a cross-section corresponding to line B-B of FIG. 6. FIG. 7C is a cross-section corresponding to line B-B of FIG. 6 with the actuator in an activated configuration.

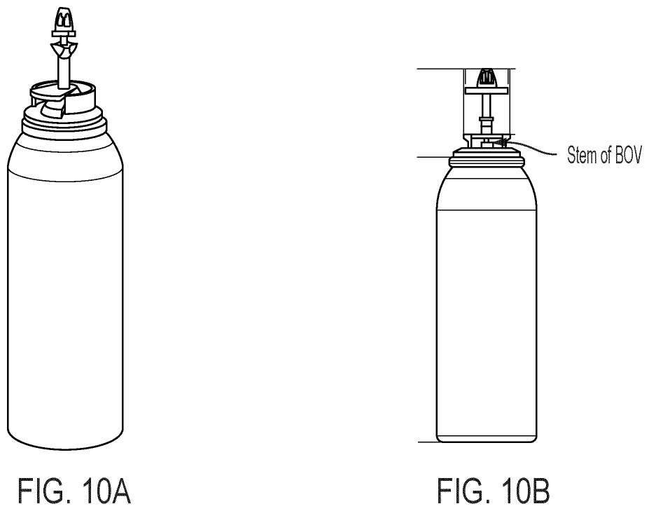

The actuator includes a frame 751 for mounting the actuator on a valve cap 758 of a fluid delivery device 757. The frame 751 can lock in place on the valve cap 758 via one or more spreaders 754 that include a hook-like shape that locks into undercuts in the valve cap 758, the undercuts being formed by the crimping process that connects the valve cap 758 with the can 757. The connection between the spreaders 754 and the valve cap 758 is ridged enough to withstand axial and angular forces up to predefined amounts such that the actuator is retained on the fluid delivery device 757 during normal usage. For example, the spreaders 754 can be configured to prevent the actuator from falling of the valve cap 758 when the assembly (the actuator mounted to the fluid delivery device) is hanging from an injection tip mounted to the actuator with the longitudinal axis of the assembly oriented perpendicularly to gravity (such as shown, for example, in FIGS. 10A-C). The actuator can include a secondary holder mechanism 756 that is pushed over the pedestal 760 of the valve cap 758 to further retain the actuator on the fluid delivery device 757 and absorb radial directed forces.

The actuator includes bridges 753 that connect the activator 752 to the frame 751. This connection may serve two purposes. First, it holds the non-activated activator 752 in place. Second, it requires a defined force in an axial direction of the fluid delivery device-to-actuator assembly in order to prevent accidental discharge of the contents of the fluid delivery device 757. The actuator includes a “total release” activator meaning once activated the total contents of the fluid delivery device 757 are released in one continuous flow. This is achieved via one or more locking mechanisms 755a of the activator 752 being pushed under and held in place respectively by the respective locking mechanism 755b of the frame 751, as shown in FIG. 7C. The locking mechanisms 755a/755b may be configured such that they are the weakest link of the whole assembly—meaning they are strong enough to keep the stem 759 of the fluid delivery device 757 pressed (in the in activated position), allowing the contents of the fluid delivery device 757 to exit the fluid delivery device, while being weak enough to break in the event of manipulation by an excessive force such that the activator 752 can separate from the frame 751, enabling the stem 759 to return to the unactivated position, which stops content flow, preventing any spillage.

### Performance Criteria

In some variations, when assembled, the injection tool (e.g., injection tip) sits in the actuator and is secured within the internal locating slots of the actuator. In certain variations, removal of the injection tool from the actuator will require a suitable force. In certain variations, a suitable rotational torque is required to rotate the injection tool in the actuator.

In some variations, the manufacture of the actuator allows for assembly of the injection tool and actuator in a way that does not cause damage to either part.

In some variations, the injection tool and actuator withstand the forces originating from the horizontal installation of the full assembled fluid delivery device, such as a 100 ml canister, with a suitable weight, without occurrence of mechanical failure or fatigue.

In some variations, the actuator/canister assembly (at the point of contact) withstand the forces originating from the horizontal installation of the full assembled canister, with a suitable weight, without occurrence of mechanical failure or fatigue.

In some variations, the point of contact between the actuator/fluid delivery device assembly requires a suitable rotational torque to rotate the actuator within the collar of the canister of the fluid delivery device.

In some variations, when assembled, the injection tool is horizontal when fitted into the actuator.

In some variations, from a fixed point of the injection tool, the actuator/fluid delivery device assembly withstands a certain force from all axis before the connection of the actuator and fluid delivery device fails. Should the actuator/fluid delivery device assembly fail, the fluid delivery device immediately de-activates.

In some variations, to ensure the deactivation of the fluid delivery device due to mechanical damage, the failure load of the stem actuation point is less than all other assembly points/possible points of failure within injection tool/actuator/fluid delivery device.

In other variations, the injection tool/actuator connection seals properly and maintains the seal against the back pressure origination from the slow release of liquid formulation with a maximum starting pressure of at least 1 bar, at least 2 bar, at least 3 bar, at least 4 bar, or at least 5 bar for the duration of the injection.

In other variations, the actuator/stem connection seals properly and maintains the seal against the back pressure origination from the slow release of liquid formulation with a maximum starting pressure of at least 1 bar, at least 2 bar, at least 3 bar, at least 4 bar, or at least 5 bar for the duration of the injection.

In yet other variations, the force required to activate the stem and allow for continuous activation is within a suitable force.

In yet other variations, once the fluid delivery device is activated, the activation is maintained during the whole duration of application of the liquid formulation until the fluid delivery device is empty.

### Commercial Advantages

The actuator described herein presents several commercial advantages. For example, the actuator is designed for an automated installation. The actuator provides a stiff connection to the injection tool (e.g., injection tip), which facilitates guiding the injection tool with the whole assembly. The injection tool along with the fluid delivery device can be pre-installed onto a plant without triggering the fluid delivery device to release its contents.

The actuator is also designed to provide a suitable clamping force to securely clamp the fluid delivery device onto the plant. In some variations, the actuator comprises four spreaders that cannot be easily loosened with levers.

The actuator does not require the use of any tubing to connect the injection tool (e.g., injection tip) to the fluid delivery device, as the actuator provides a stiff connection between the injection tool and fluid delivery device.

The actuators as described herein may be installed according to the exemplary process depicted in FIGS. 10A-10C. In FIG. 10A, the injection tool (e.g., injection tip) is first installed into the trunk or stem of the plant. The tip is positioned such that there is enough space for the fluid delivery device (e.g., the spraycan) and there are no branches in the way. In FIG. 10B, the injection tool is then set by pressing on the top beam. Then, in FIG. 10C, the fluid delivery device is pushed. The predetermined breaking points of the actuator bridges allowing the activator to snap into the frame.

### Injection Tools

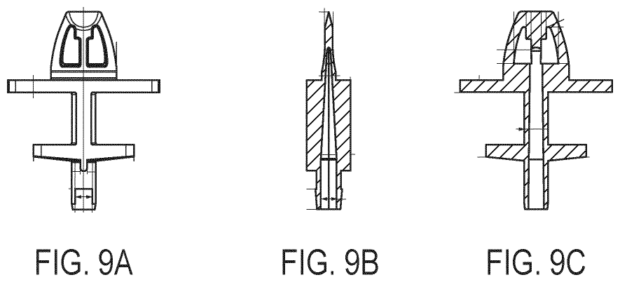

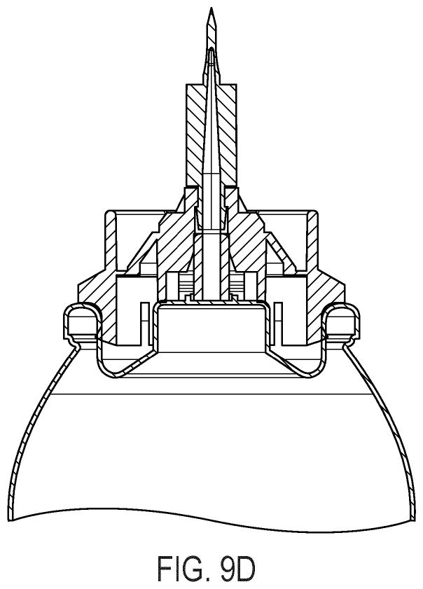

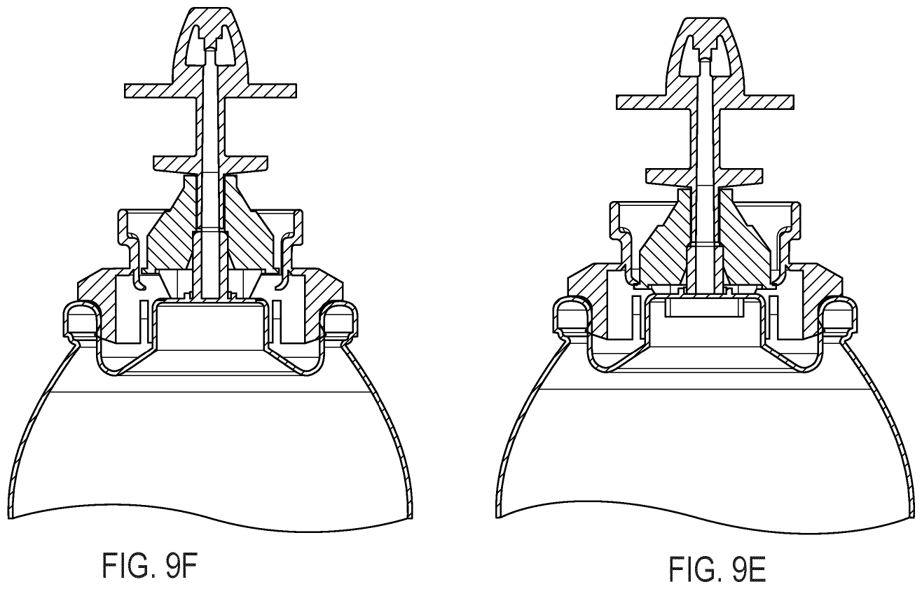

Any injection tools compatible with the actuator and the fluid delivery devices described herein may be used. FIGS. 9A-9C depict an exemplary injection tool, suitable for use with the actuators and fluid delivery devices described herein. FIGS. 9D-9F are cross sections of the injection tool of FIG. 9A-9C mounted to an actuator that is mounted to a fluid delivery device. FIGS. 9D and 9E are orthogonal cross-sections showing the assembly in a non-activated configuration and FIG. 9F is a cross-section through the same plane as FIG. 9E showing the assembly in the activated configuration.

In some aspects, provided are injection tools that include a penetrating distribution body, at least a portion of which is designed to be lodged into a plant, for example, the stem or trunk of a plant. The penetrating distribution body has a channel system (having one or more channels) through which fluid can flow, terminating in an entry port through which fluid enters the injection tool and one or more distribution ports through which fluid is delivered to the interior of the plant. In some embodiments, the channel system provides fluid communication between the distribution ports and entry port.

In some embodiments, the distribution ports are recessed from an exterior of a body profile of the penetrating distribution body, and accordingly remain clear of plant tissue. For example, one or more distribution ports are provided along the troughs of anchor elements (e.g., threading, flutes, serrations, cleats, scalloped surfaces or the like), within distribution reservoirs within the body profile of the penetrating distribution body. In some embodiments, the one or more distribution ports are within the body profile and with penetration of the plant tissue the ports are not engaged with plant tissue in a manner that promotes clogging. Instead, the one or more distribution ports are recessed from the penetrating element and, at least in some examples, the plant tissue itself. Accordingly, liquid formulations delivered to the injection tool are readily received in the plant and delivered with minimal pressure or effort. Further, in examples including cavities, the proximate walls, surfaces or the like of the injection tool in combination with the surrounding plant tissue provide reservoirs within the plant, and the liquid formulations reside in these reservoirs for gradual uptake by the plant.

In one embodiment, the injection tool comprises: a base including an inlet port; and a penetrating distribution body having a wedge type body profile extending along a longitudinal body axis. In some variations, the penetrating distribution body includes: a cutting edge along the front face of the penetrating distribution body directed distally away from the base, a penetrating element that extends from the cutting edge and proximate to a distal portion of the penetrating distribution body to a proximal portion of the penetration distribution body, and a distribution element that includes distribution ports and distribution reservoirs.

In some variations of the foregoing, the injection tool further comprises: a beam connected to the base; and a connector that extends from the base and is connected to the beam. In some variations, the connector is configured to insert into any of the actuators described herein so that the injection tool is in fluid connection with the fluid delivery device by connection through the actuator.

In one or more examples, the material of the injection tool may be selected to penetrate the plant tissue without bending or breaking. In one or more embodiments, the injection tool may be formed from a material having a hardness of between 30 HRC and 50 HRC, or between 35 HRC and 45 HRC. In some embodiments, the injection tool may be formed from a metal alloy such as hardened stainless steel.

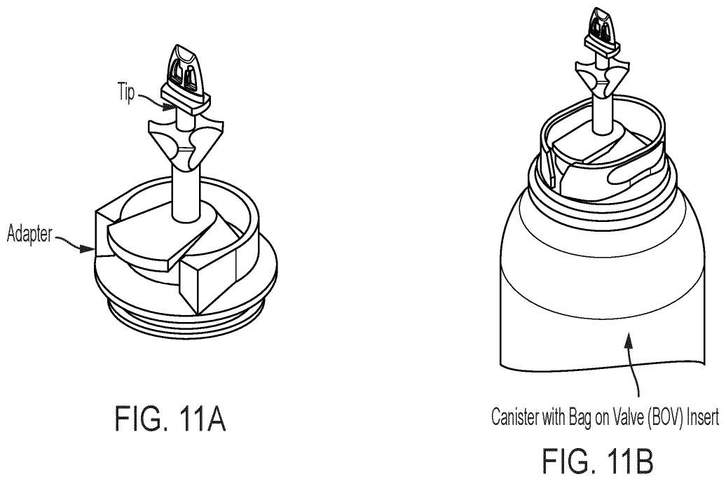

FIG. 11A depicts an exemplary injection tool/actuator assembly. When the injection tool is installed into the plant, the connector does not lodge into the plant.

In some embodiments, the injection tools described herein are installed in plants having relatively small and large sizes or diameters (e.g., trunk or stem diameters). In one example, the portions of the injection tools installed in plants have dimensions of around 5 mm or less (e.g., width) and 1 mm or less (e.g., height) and accordingly the tools are configured for installation in plants with stems, trunks, roots, limbs or the like of 5 mm or more in size, such as diameter.

In some embodiments, the lodged portion of the injection tool is sized and shaped to minimize damage to the target plant when inserted into the plant, while maintaining efficient functionality of the injection tool in delivering the desired dosing of liquid formulation over the desired time period directly to the active vasculature of the plant. In some variations, penetrating element and tool base are cooperatively sized and shaped to work together to minimize damage to the target plant while maintaining efficient functionality of the tip. For example, the length of penetrating element may be chosen to be less than the depth of the sapwood in the trunk of the tree and tool base is configured with a flange abutting the bottom end of penetrating element. In some variations, the flange is sized and shaped to mitigate the risk of inserting the injection tool beyond the end of penetrating element abutting flange and therefore beyond the inner circumference of the sapwood and into the heartwood. In some variations, flange has a width that is wider than the widest part of penetrating element. In one example, the multiport injection tip includes one or more dimensions configured to minimize trauma to the plant caused during installation. The minimal profile of the tip (as well as other tip embodiments described herein) minimizes trauma to a plant in comparison to larger profile devices including syringes, plug, pegs or the like having dimensions of around 7 mm (7.14 mm in one example) a full 2 mm larger than the example tip. Accordingly, the potential for tree damage is reduced and the potential for fungal, bacterial, and insect ingress is minimized (e.g., reduced or eliminated). In one example, the tip as well as the other tip examples described herein are readily used with plants having stems, trunks, limbs or the like having diameters larger than 4.68 mm including, but not limited to, fruit trees, nut trees, berry shrubs, flowering plants as well as arbor and forest trees.

In certain embodiments, the injection tools selected allow for precision delivery (also referred to as “precision injection”) of a formulation into the plant. Precision delivery refers to delivering the formulation only or substantially only into a target location in the plant. For example, in some embodiments, the target location is the active vasculature of the tree. In some variations, the active vasculature of a tree is the xylem and/or the phloem. In other embodiments, precisely delivering the liquid formulation comprises inserting the injection tool such that the distribution reservoir is positioned in and no further than the active vasculature of the plant.

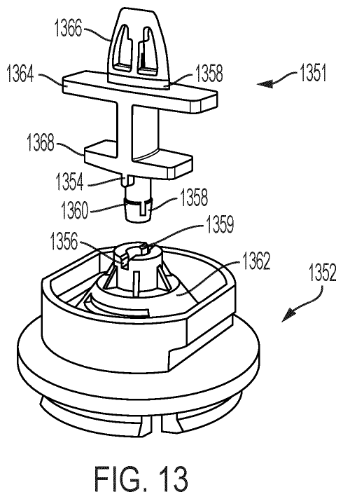

FIG. 13 illustrates the mounting of an exemplary injection tool 1351 to an exemplary actuator 1352. The injection tool 1351 includes one or more positioning features 1354 that may mate with corresponding positioning features 1356 of the actuator 1352 to align the injection tool 1351 to the actuator 1352. The male port 1358 of the of the injection tool 1351 can include one or more rims 1360 that allow the male port 1358 to be pushed into the female port 1359 of the activator 1362 of the actuator 1352 and retained in the female port 1359 of the activator 1362 by snapping behind corresponding undercuts within the female port 1359 (see, e.g., FIGS. 9D-9F). The male port 1358 and female port 1359 can be sized to have small or no clearance (e.g., a press fit) when mated, such as to maintain a seal. Alternatively, clearance may be provided and the mating between the one or more rims 1360 and the associated undercuts may provide the sealing when forced together under pressure of the fluid outflow during activation.

The base of the injection tool 1351 is shaped like a sideway H for easier placing. The top beam 1314 ensures a large contact surface for the tree to not damage it and can also be used to transmit the force to the cutting part 1313. The bottom beam 1368 can be smaller because its only use is to pull the tip out of the tree which needs less force then pushing it in. The injection tool 1351 may be manufactured by additive manufacturing or injection molding.

The bottom 1368 of the blade 1313 may be configured to provide a thickened sealing surface designed to spread the wood and create an equal pressure around the tip of the injection tool 1351 when inserted into a tree, thus providing a seal. This can improve the reliability and stability of the blade 1313.

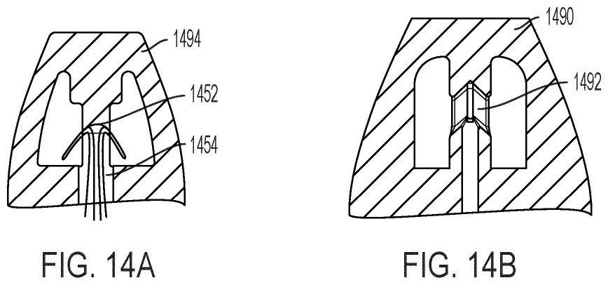

FIG. 14A is a cross-section of an exemplary blade portion of an exemplary injection tool 1494. The top 1452 of the main channel 1454 has a curvature that redirects the contents ejected from the fluid delivery device backwards. This can help prevent clogging of the injection tool. Injection tool 1494 may be made via injection molding or additive manufacturing. FIG. 14B is a cross-section of another example of an injection tool. Injection tool 1490 includes backward channels 1492 that can prevent clogging. Due to the relatively complex geometry of the backward channels 1492, injection tool 1490 may require additive manufacturing or injection molding.

### Fluid Delivery Device

Any suitable fluid delivery devices may be used with the actuators and injection tools described herein, and in the injection systems described herein. In some embodiments, the fluid delivery device comprises a canister. In some embodiments, the canister has a bag-on-valve insert, as depicted in FIGS. 10B and 11B. With reference to FIG. 10B, the bag-on-valve insert is connected to a stem that receives the connector of the injection tool.

In one variation, the fluid delivery device is a spraycan.

In some embodiments, the fluid delivery device contains any suitable liquid formulations and active ingredients, including as described below.

### Injection Systems

In some aspects, provided herein are injection systems comprising: an injection tool, an actuator, and a fluid delivery device. In some variations, the injection tool is connected to the actuator through the connector of the injection tool that extends from the base of the tool body, and is configured to connect with the stem of the fluid delivery device. The injection tool is in fluid connection with the fluid delivery device by connection through the actuator. The term “in fluid connection” relates to a connection enabling a transfer of fluid, particularly from the fluid delivery device to the injection tool.

FIGS. 10A, 10B and 10B depict exemplary injection systems, in which an injection tool is connected to the actuator through the stem, and the actuator is installed onto a fluid delivery device.

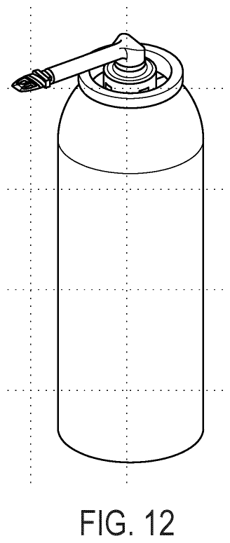

FIG. 12 depicts another exemplary injection system, which a different exemplary actuator. The actuator depicted in this figure connects the injection tool horizontally.

### Liquid Formulations

Any suitable liquid formulations (e.g., active ingredient) may be used with manual tip setters and/or manual tip setting systems described herein. In some embodiments, the liquid formulation is water soluble. In some variations, the liquid formulation comprises nutrients. In some variations, the liquid formulation comprises micronutrients. In some variations, the liquid formulation is a semi-liquid formulation. In some variations, the liquid formulation is a gel formulation. In some variations, the liquid formulation is delivered as a semi-liquid or a gel formulation.

Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples of typical formulations include water-soluble liquids (SL), emulsifiable concentrates (EC), emulsions in water (EW), suspension concentrates (SC, SE, FS, OD), water-dispersible granules (WG) and fluids (which include one or more of a liquid, gas, gel, vapor, aerosol or the like). These and other possible types of formulation are described, for example, by Crop Life International and in Pesticide Specifications, Manual on development and use of FAO and WHO specifications for pesticides, FAO Plant Production and Protection Papers, prepared by the FAO/WHO Joint Meeting on Pesticide Specifications, 2004, ISBN: 9251048576; “Catalogue of pesticide formulation types and international coding system,” Technical Monograph No. 2, 6th Ed. May 2008, CropLife International.

In some embodiments, compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples for suitable auxiliaries are solvents, liquid carriers, surfactants, dispersants, emulsifiers, wetters, adjuvants, solubilizers, penetration enhancers, protective colloids, humectants, repellents, attractants, feeding stimulants, compatibilizers, bactericides, anti-freezing agents, antifoaming agents, colorants, stabilizers or nutrients, UV protectants, tackifiers, and/or binders. Specific examples for each of these auxiliaries are well known to the person of ordinary skill in the art, see, for example, US 2015/0296801 A1.

The compositions can optionally comprise 0.1-80% stabilizers and/or nutrients and 0.1-10% UV protectants. General examples of suitable ratios for multiple formulation types referenced above are given in Agrow Reports DS243, T&F Informa, London, 2005.

At certain application rates, the compositions and/or formulations according to the disclosure may also have a strengthening effect in plants. “Plant-strengthening” (resistance-inducing) substances are to be understood as meaning, in the present context, those substances or combinations of substances which are capable of stimulating the defence system of plants in such a way that, when subsequently inoculated with harmful microorganisms, the treated plants display a substantial degree of resistance to these microorganisms.

### Active Ingredients

In some embodiments, when applying active ingredients, the application can be continuous over a longer period or intervals. In some variations, the application could also be coupled with a disease monitoring system and be triggered “on demand.” In some variations, the formulations can comprise between 0.5% and 90% by weight of active compound, based on the weight of the formulation.

Numerous active ingredients can be used in the manual tip setters and manual tip setting systems described herein. The active ingredients specified herein by their “common name” are known and described, for example, in The Pesticide Manual (18^{th} edition, Ed. Dr. J A Turner (2018), which includes, among other agents, herbicides, fungicides, insecticides, acaricides, nematocides, plant growth regulators, repellants, synergists) or can be searched in the internet (e.g., alanwood. net/pesticides). Further, the active ingredient can be selected from the following groups of compounds and compositions:
1. Fungicides
1.1 Respiration inhibitors
1.1.1 Inhibitors of complex III at Qo site, for example, azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyrao-xystrobin, trifloxystrobin, pyribencarb, triclopyricarb/chlorodincarb, famoxadone, and/or fenamidone;
1.1.2 Inhibitors of complex III at Qi site: cyazofamid and/or amisulbrom;
1.1.3 Inhibitors of complex II: flutolanil, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam and/or thifluzamide;
1.1.4 Other respiration inhibitors (e.g., complex I, uncouplers): diflumetorim;
1.1.5 Nitrophenyl derivates: binapacryl, dinobuton, dinocap, fluazinam; ferimzone; organometal compounds: fentin-acetate, fentin chloride and/or fentin hydroxide; ametoctradin; and/or silthiofam;
1.2 Sterol biosynthesis inhibitors (SBI fungicides)
1.2.1. C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and/or uniconazole;
1.2.2 Imidazoles: imazalil, pefurazoate, prochloraz, triflumizol; pyrimidines, pyridines and piperazines: fenarimol, nuarimol, pyrifenox, triforine; Delta14-reductase inhibitors: aldimorph, dodemorph, dodemorph-acetate, fenpropimorph, tridemorph, fenpropidin, piperalin, spiroxamine; Inhibitors of 3-keto reductase: fenhexamid;
1.3 Nucleic acid synthesis inhibitors:
1.3.1 Phenylamides or acyl amino acid fungicides: benalaxyl, benalaxyl-M, kiral-axyl, metalaxyl, ofurace, oxadixyl; others: hymexazole, octhilinone, oxolinic acid, bupirimate and/or, 5-fluorocytosine;
1.4 Inhibitors of cell division and cytoskeleton
1.4.1 Tubulin inhibitors: benzimidazoles, thiophanates: benomyl, carbendazim, fuberidazole, thiabendazole, thiophanate-methyl; triazolopyrimidines:
1.4.2 Cell division inhibitors: diethofencarb, ethaboxam, pencycuron, fluopicolide, zoxamide, metrafenone and/or, pyriofenone;
1.5 Inhibitors of amino acid and protein synthesis
1.5.1 Methionine synthesis inhibitors (anilino-pyrimidines): cyprodinil, mepanipyrim, pyrimethanil; protein synthesis inhibitors: blasticidin-S, kasugamycin, kasugamycin hydrochloride-hydrate, mildiomycin, streptomycin, oxytetracyclin, polyoxine, validamycin A;
1.6. Signal transduction inhibitors
1.6.1 MAP/histidine kinase inhibitors: fluoroimid, iprodione, procymidone, vinclozolin, fenpiclonil, fludioxonil; G protein inhibitors: quinoxyfen;
1.7 Lipid and membrane synthesis inhibitors
1.7.1 Phospholipid biosynthesis inhibitors: edifenphos, iprobenfos, pyrazophos, isoprothiolane; lipid peroxidation: dicloran, quintozene, tecnazene, tolclofos-methyl, biphenyl, chloroneb, etridiazole; phospholipid biosynthesis and cell wall deposition: dimethomorph, flumorph, mandipropamid, pyrimorph, benthiavalicarb, iprovalicarb, valifenalate;
1.7.2 Compounds affecting cell membrane permeability and fatty acids: propamocarb, propamocarb-hydrochloridfatty acid amide
1.8 Inhibitors with Multi Site Action
1.8.1 Inorganic active substances: Bordeaux mixture, copper acetate, copper hydroxide, copper oxychloride, basic copper sulfate, sulfur; thio-and dithiocarbamates: ferbam, mancozeb, maneb, metam, metiram, propineb, thiram, zineb, ziram; organochlorine compounds (e.g., phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, and others: guanidine, dodine, dodine free base, guazatine, guazatine-acetate, iminoctadine, iminoctadine-triacetate, iminoctadinetris(albesilate), dithianon;
1.9 Cell wall synthesis inhibitors
1.9.1 Inhibitors of glucan synthesis: validamycin, polyoxin B; melanin synthesis inhibitors: pyroquilon, tricyclazole, carpropamid, dicyclomet and/or fenoxanil;
1.10 Plant defence inducers
1.10.1 Acibenzolar-S-methyl, probenazole, isotianil, tiadinil, prohexadione-calcium; phosphonates: fosetyl, fosetyl-aluminum, phosphorous acid and its salts;
1.11 Unknown mode of action
1.11.1 Bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxine-copper, picarbutrazox, proquinazid, tebufloquin, tecloftalam and/or triazoxide;
1.12 Antifungal biological Control Agents: Ampelomyces quisqualis (e.g., AQ 10® from Intrachem Bio GmbH & Co. KG, Germany), Aspergillus flavus (e.g., AFLAGUARD® from Syngenta, CH), Aureobasidium pullulans (e.g., BOTECTOR® from bio-ferm GmbH, Germany), Bacillus pumilus (e.g., NRRL Accession No. B-30087 in SONATA® and BALLAD® Plus from AgraQuest Inc., USA), Bacillus subtilis (e.g., isolate NRRL-Nr. B-21661 in RHAPSODY®, SERENADER® MAX and SERENADE® ASO from AgraQuest Inc., USA), Bacillus subtilis var. amyloliquefaciens FZB24 (e.g., TAEGRO® from Novozyme Biologicals, Inc., USA), Candida oleophila I-82 (e.g., ASPIRE® from Ecogen Inc., USA), Candida saitoana (e.g., BIOCURE® (in mixture with lysozyme) and BIOCOAT® from Micro Flo Company, USA (BASF SE) and Arysta), Chitosan (e.g., ARMOUR-ZEN from BotriZen Ltd., NZ), Clonostachys rosea f. catenulata, also named Gliocladium catenulatum (e.g., isolate J1446: PRESTOP® from Verdera, Finland), Coniothyrium minitans (e.g., CONTANS® from Prophyta, Germany), Cryphonectria parasitica (e.g., Endothia parasitica from CNICM, France), Cryptococcus albidus (e.g., YIELD PLUS® from Anchor Bio-Technologies, South Africa), Fusarium oxysporum (e.g., BIOFOX® from S.I.A.P.A., Italy, FUSACLEAN® from Natural Plant Protection, France), Metschnikowia fructicola (e.g., SHEMER® from Agrogreen, Israel), Microdochium dimerum (e.g., ANTIBOT® from Agrauxine, France), Phlebiopsis gigantea (e.g., ROTSOP® from Verdera, Finland), Pseudozyma flocculosa (e.g., SPORODEX® from Plant Products Co. Ltd., Canada), Pythium oligandrum DV74 (e.g., POLYVERSUM® from Remeslo SSRO, Biopreparaty, Czech Rep.), Reynoutria sachlinensis (e.g., REGALIA® from Marrone Bio-Innovations, USA), Talaromyces flavus V117b (e.g., PROTUS® from Prophyta, Germany), Trichoderma asperellum SKT-1 (e.g., ECO-HOPE® from Kumiai Chemical Industry Co., Ltd., Japan), T. atroviride LC52 (e.g., SENTINEL® from Agrimm Technologies Ltd, NZ), T. harzianum T-22 (e.g., PLANTSHIELD® der Firma BioWorks Inc., USA), T. harzianum TH 35 (e.g., ROOT PRO® from Mycontrol Ltd., Israel), T. harzianum T-39 (e.g., TRICHODEX® and TRICHODERMA 2000® from Mycontrol Ltd., Israel and Makhteshim Ltd., Israel), T. harzianum and T. viride (e.g., TRICHOPEL from Agrimm Technologies Ltd, NZ), T. harzianum ICC012 and T. viride ICC080 (e.g., REMEDIER® WP from Isagro Ricerca, Italy), T. polysporum and/or T. harzianum (e.g., BINAB® from BINAB Bio-Innovation AB, Sweden), T. stromaticum (e.g., TRICOVAB® from C.E.P.L.A.C., Brazil), T. virens GL-21 (e.g., SOILGARD® from Certis LLC, USA), T. viride (e.g., TRIECO® from Ecosense Labs. (India) Pvt. Ltd., Indien, BIO-CURE® F from T. Stanes & Co. Ltd., Indien), T. viride TV1 (e.g., T. viride TV1 from Agribiotec srl, Italy), Ulocladium oudemansii HRU3 (e.g., BOTRY-ZEN® from Botry-Zen Ltd, NZ), Beauveria bassiana PPRI 5339 (commercially available from Becker Underwood as product “BroadBand”), Metarhizium anisopliae FI-1045 (commercially available from Becker Underwood as product “BioCane”), Metarhizium anisopliae var. acridum FI-985 (commercially available from Becker Underwood as product “GreenGuard”), and/or Metarhizium anisopliae var. acridum IMI 330189 (commercially available from Becker Underwood as product “Green Muscle”).

In some embodiments, active ingredients can also include protein or secondary metabolites. The term “protein or secondary metabolites” refers to any compound, substance or by-product of a fermentation of a microorganism that has pesticidal activity. The definition comprises any compound, substance or by-product of a fermentation of a microorganism that has pestocodal, including, fungicidal or insecticidal, activity. Examples of such proteins or secondary metabolites are Harpin (isolated by Erwinia amylovora, product known as e.g., Harp-N-Tek™, Messenger®, Employ™, ProAct™); and/or terpene constituents and mixture of terpenes, i.e. a-terpinene, p-cymene and limonene (product known as e.g., Requiem® from Bayer CropScience LP, US).

In some embodiments, useful proteins may also include antibodies against fungal target proteins, or other proteins with antifungal activity such as defensins and/or proteinase inhibitor. Defensins may include, for example, NaD1, PhD1A, PhD2, Tomdef2, RsAFP2, RsAFP1, RsAFP3 and RsAFP4 from radish, DmAMP1 from dahlia, MsDef1, MtDef2, CtAMP1, PsD1, HsAFP1, VaD1, VrD2, ZmESR6, AhAMP1 and AhAMP4 from Aesculus hippocatanum, AfIAFP from alfalfa, NaD2, AX1, AX2, BSD1, EGAD1, HvAMP1, JI-2, PgD1, SD2, SoD2, WT1, p139 and p1230 from pea. Proteinase inhibitors may include proteinase inhibitor from the following classes: serine-, cysteine-, aspartic- and metallo-proteinase inhibitors and carboxypeptidases such as StPin1A (U.S. Pat. No. 7,462,695) or Bovine Trypsin Inhibitor I-P.
2. Insecticidal compound
2.1 Acetylcholine esterase inhibitors from the class of carbamates: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and/or, triazamate;
2.2 Acetylcholine esterase inhibitors from the class of organophosphates: acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl)salicylate, isoxathion, malathion, mecarbam, methamidophos, methidathion, mevinphos, monocrotophos, nalad, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and/or vamidothion;
2.3 GABA-gated chloride channel antagonists
2.4 Cyclodiene organochlorine compounds: endosulfan; orM-2.B fiproles (phenylpyrazoles): ethiprole, fipronil, flufiprole, pyrafluprole, or pyriprole;
2.5 Sodium channel modulators from the class of pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, betacyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, momfluorothrin, empenthrin, esfenvalerate, etofenprox, fenpropathrin, fenvalerate, flucythrinate, flumethrin, tau-fluvalinate, halfenprox, imiprothrin, meperfluthrin, metofluthrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin, DDT and/or, methoxychlor;
2.6 Nicotinic acteylcholine receptor agonists from the class of neonicotinoids: acteamiprid, chlothianidin, cycloxaprid, dinotefuran, flupyradifurone, imidacloprid, nitenpyram, sulfoxaflor, thiacloprid and/or thiamethoxam;
2.7 Allosteric nicotinic acteylcholine receptor activators from the class of spinosyns: spinosad, spinetoram;
2.8 Chloride channel activators from the class of mectins: abamectin, emamectin benzoate, ivermectin, lepimectin and/or milbemectin;
2.9 Juvenile hormone mimics: hydroprene, kinoprene, methoprene, fenoxycarb and/or pyriproxyfen;
2.10 Non-specific multi-site inhibitors: methyl bromide and other alkyl halides, chloropicrin, sulfuryl fluoride, borax and/or tartar emetic;
2.11 Selective homopteran feeding blockers: pymetrozine, flonicamid and/or pyrifluquinazon;
2.12 Mite growth inhibitors: clofentezine, hexythiazox, diflovidazin and/or etoxazole;
2.13 Inhibitors of mitochondrial ATP synthase: diafenthiuron, azocyclotin, cyhexatin, fenbutatin oxide, propargite and/or tetradifon;
2.14 Uncouplers of oxidative phosphorylation: chlorfenapyr, DNOC and/or sulfluramid; M-13 nicotinic acetylcholine receptor channel blockers: bensultap, cartap hydrochloride, thiocyclam and/or thiosultap sodium;
2.15 Inhibitors of the chitin biosynthesis type 0 (benzoylurea class): bistrifluron, chlorfluazuron, diflubenzuron, flucycloxuron, flufenoxuron, hexaflumuron, lufenuron, novaluron, noviflumuron, teflubenzuron and/or, triflumuron;
2.16 Inhibitors of the chitin biosynthesis type 1: buprofezin;
2.17 Moulting disruptors: cyromazine;
2.18 Ecdyson receptor agonists: methoxyfenozide, tebufenozide, halofenozide, fufenozide and/or chromafenozide;
2.19 Octopamin receptor agonists: amitraz;
2.20 Mitochondrial complex III electron transport inhibitors: hydramethylnon, acequinocyl, flometoquin, fluacrypyrim and/or pyriminostrobin;
2.21 Mitochondrial complex I electron transport inhibitors: fenazaquin, fenpyroximate, pyrimidifen, pyridaben, tebufenpyrad, tolfenpyrad, flufenerim and/or rotenone;
2.22 Voltage-dependent sodium channel blockers: indoxacarb and/or metaflumizone
2.23 Inhibitors of the lipid synthesis, inhibitors of acetyl CoA carboxylase: spirodiclofen, spiromesifen and/or spirotetramat;
2.24 Mitochondrial complex II electron transport inhibitors: cyenopyrafen, cyflumetofen and/or pyflubumide;
2.25 Ryanodine receptor-modulators from the class of diamides: flubendiamide, chloranthraniliprole (rynaxypyr) and/or cyanthraniliprole (cyazypyr),
2.26 Others: afidopyropen,
2.27 Insecticidal biological control agents: Bacillus firmus (e.g., Bacillus firmus CNCM 1-1582, e.g., WO09126473A1 and WO09124707 A2, commercially available as “Votivo”) and/or δ-endotoxins from Bacillus thuringiensis (Bt).
3. A plant growth regulator:
3.1 Antiauxins: clofibric acid and/or 2,3,5-tri-iodobenzoic acid;
3.2 Auxins: 4-CPA, 2,4-D, 2,4-DB, 2,4-DEP, dichlorprop, fenoprop, IAA (indole- 3-acetic acid), IBA, naphthaleneacetamide, α-naphthaleneacetic acid, 1-naphthol, naphthoxyacetic acid, potassium naphthenate, sodium naphthenate and/or 2,4,5-T;
3.3 Cytokinins: 2iP, 6-benzylaminopurine (6-BA), 2,6-dimethylpyridine and/or kinetin, zeatin;
3.4 Defoliants: calcium cyanamide, dimethipin, endothal, merphos, metoxuron, pentachlorophenol, thidiazuron, tribufos and/or tributyl phosphorotrithioate;
3.5 Ethylene modulators: aviglycine, 1-methylcyclopropene (1-MCP), prohexadione (prohexadione calcium) and/or trinexapac (trinexapac-ethyl);
3.6 Ethylene releasers: ACC, etacelasil, ethephon, glyoxime; Gibberellins: gibberelline, gibberellic acid;
3.7 Growth inhibitors: abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham and/or 2,3,5-tri-iodobenzoic acid;
3.8 Morphactins: chlorfluren, chlorflurenol, dichlorflurenol and/or flurenol;
3.9 Growth retardants: chlormequat (chlormequat chloride), daminozide, flurprimidol, mefluidide, paclobutrazol, tetcyclacis, uniconazole and/or metconazole;
3.10 Growth stimulators: brassinolide, forchlorfenuron and/or, hymexazol;
3.11 Unclassified plant growth regulators/classification unknown: amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, inabenfide, karetazan, lead arsenate, methasulfocarb, pydanon, sintofen and/or, triapenthenol.

In one embodiment, the fungicidal compound is selected from the group consisting of Dimoxystrobin, Pyraclostrobin, Azoxystrobin, Trifloxystrobin, Picoxystrobin, Cyazofamid, Boscalid, Fluoxapyroxad, Fluopyram, Bixafen, Isopyrazam, Benzovindiflupyr, Penthiopyrad, Ametoctradin, Difenoconazole, Metconazole, Prothioconazole, Tebuconazole, Propiconazole, Cyproconazole, Penconazole, Myclobutanil, Tetraconazole, Hexaconazole, Metrafenone, Zoxamid, Pyrimethanil, Cyprodinil, Metalaxyl, Fludioxonil, Dimethomorph, Mandipropamid, Tricyclazole, Copper, Metiram, Chlorothalonil, Dithianon, Fluazinam, Folpet, Fosetyl-Al, Captan, Cymoxanil, Mancozeb, Kresoxim-methyl, Oryzastrobin, Epoxiconazole, Fluquinconazole, Triticonazole, Fenpropimorph and Iprodione.

In one embodiment, the plant growth regulator is selected from the group consisting of 6-benzylaminopurine (=N-6-benzyladenine), chlormequat (chlormequat chloride), choline chloride, cyclanilide, dikegulac, diflufenzopyr, dimethipin, ethephon, flumetralin, fluthiacet, forchlorfenuron, gibberellic acid, inabenfide, maleic hydrazide, mepiquat (mepiquat chloride), 1-methylcyclopropene (1-MCP), paclobutrazol, prohexadione (prohexadione calcium), prohydrojasmon, thidiazuron, triapenthenol, Tributyl phosphorotrithioate, trinexapac-ethyl and uniconazole.

In another embodiment, the active ingredient is a biological control agent such as a bio-pesticide. In some embodiments, compared to conventional synthetic chemical pesticides, bio-pesticides are non-toxic, safe to use, and can have high specificity. In some variations, these can be used as a preventative (or curative) tool to manage diseases, nematodes and insects and other pests. In some embodiments, bio-pesticides allow for the reduction in the use of traditional chemical-based pesticides without affecting yields. The use of biological pesticides is compatible with the use for food and feed production and many of the biological agents are approved for consumption. This allows an all year use in food production systems like wine, banana, cocoa, coffee, and fruit plantations etc. where pest control is a major and increasing challenge. In one embodiment, the tools, systems and methods of the disclosure are employed in organic farming.

In one embodiment, the active ingredients are those which provide a systemic effect.

### Penetrants

In some embodiments, penetrants which facilitate and/or enhance the uptake and distribution of the active ingredient in the target plant can be used in the manual tip setters and manual tip setting systems described herein. Suitable penetrants in the present context include all those substances which are typically used in order to enhance the penetration of active agrochemical compounds into plants. Examples include alcohol alkoxylates, such as coconut fatty ethoxylate, isotridecyl ethoxylate, fatty acid esters, such as rapeseed or soybean oil methyl esters, fatty amine alkoxylates, such as tallowamine ethoxylate, or ammonium and/or phosphonium salts, such as ammonium sulphate or diammonium hydrogen phosphate.

### Uses of the Manual Tip Setters and Manual Tip Setting Systems

The manual tip setters and manual tip setting systems described herein can be used with any number of known injection methods and protocols such as, for example, those disclosed in PCT applications WO 2012/114197 or WO 2013/149993. The appropriate method and protocol will depend upon various factors including the nozzle tip, the tree species, the target (insect, nematode, disease, abiotic stress, etc.), the injection fluid components and/or viscosity, the dose volume required and the injection pressure.

In some embodiments, the method comprises delivering a formulation comprising one or more nutrients into a plant. In some embodiments, the method comprises precision delivery of a formulation into the plant. In some variations, precisely delivering the liquid formulation comprises inserting the injection tool such that the distribution reservoir is positioned in and no further than the active vasculature of the plant.

In some variations, the liquid formulation is delivered into and no further than the active vasculature of the plant when the injection tool is inserted into the post portion of the plant. In some variations, the liquid formulation is delivered into and no further than the active vasculature of the plant when the injection tool is inserted into the stem or trunk of the plant. In some variation, the liquid formulation is delivered into and no further than the xylem, or the phloem or both of the plant when the injection tool is inserted into the post portion of the plant. In one variation, the liquid formulation is delivered into and no further than the xylem, or the phloem or both of the plant when the injection tool is inserted into the stem or trunk of the plant.

In some embodiments, the methods deliver at least 50%, at least 60%, at least 70%, at least 80%, at least 90%, at least 95%, at least 96%, at least 97%, at least 98% or at least 99% of the liquid formulation into to the active vasculature of the plant. In some variation, the methods deliver at least 50%, at least 60%, at least 70%, at least 80%, at least 90%, at least 95%, at least 96%, at least 97%, at least 98% or at least 99% of the liquid formulation into the xylem and/or phloem of the plant.

In some embodiments, the method comprises injecting liquid formulation into the vasculature through one or more sites on post portion of the plant. In some embodiments, the method comprises injecting liquid formulation into the vasculature through one or more sites on the trunk of the tree. In embodiments where the formulation is injected through multiple injection sites, a plurality of the injection systems described herein may be used. In some embodiments where the formulation is injected through multiple injection sites, the system comprises multiple injection tools operatively connected to a single fluid delivery system.

The manual tip setters and manual tip setting systems described herein generally provide one or more commercial advantages over the tools, systems and methods currently known in the art. Advantages include one or more of a faster return to the production yields pre-infection, fast response (e.g., curing), lower volumes of formulation needed, less loss of formulation to the environment, less damage to the tree, response in old trees including trees older than 100 years, response in trees with significant disease symptoms (e.g., with 50% or less remaining canopy foliage and faster administration to the trees).

The manual tip setters and manual tip setting systems described herein are suitable for being applied to various different plants. Thereby, the shape and dimensions of the injection tools involved advantageously are adapted to the intended application. More specifically, the injection tool can be designed for being applied to comparably large plants and specifically to trees, bushes or other woody plants. In other variations, the injection tool can be designed for being applied to comparably small or smaller plants. For example, in some variations, injection tools suitable for woody plants may have a total length of more than 50 mm or in a range of between 60 mm and 200 mm. The respective penetrating distribution bodies (e.g., shaft or wedge body profiles) include lengths of 35 mm or more and in some examples are in a range of between approximately 35 mm and 160 mm, and/or a width of 30 mm or more or are in a range of between approximately 35 mm and 150 mm. In contrast, in other variations, injection tools intended for comparably small plants optionally have a total length of between approximately 3 mm and 20 mm, between approximately 6 mm and 16 mm, or less than 10 mm.

In a further other aspect, described herein is a process of modulating the phenotype of a plant or a multitude of plants, said process including the steps of (i) installing a plant injection system according to the disclosure provided herein in the plant or multitude of plants, and (ii) applying a liquid formulation of an active ingredient to modulate the phenotype of the plant.

In some embodiments, the active ingredient is selected from the group consisting of (i) pesticides and (ii) growth regulators. In some embodiments, the active ingredient is a biological compound or composition approved for food and feed application.

### Suitable Plants

In some embodiments, the manual tip setters and manual tip setting systems described herein are inserted into the trunk/stem of the plant. In some variations, the trunk/stem (i) comprise a vascular system connected to the plant and/or (ii) has a diameter of at least 1 cm, such as at least 2 cm or 3 cm, or at least 4 cm or 5 cm. The trunk/stem may, for example, include trunks and branches of tree, large petioles, but also “false stems” or pseudostems of plants like bananas, which consist of tightly packed sheaths. Trunks/stems can be woody or non-woody.

Plants suitable for use with the manual tip setters and manual tip setting systems described herein, can be selected from Tree Crops (e.g., Walnuts, Almonds, Pecans, Hazelnuts, Pistachios, etc.), citrus trees (Citrus spp. e.g., orange, lemon, grapefruit, mandarins etc.), Fruit Crops (such as pomes, stone fruits or soft fruits, for example apples, pears, plums, peaches, cherries etc.), Vine Crops (e.g., Grapes, Blueberries, Blackberries, etc.), coffee (Coffea spp.), coconut (Cocos iiucifera), pineapple (Ananas comosus), cocoa (Theobroma cacao), tea (Camellia sinensis), banana (Musa spp.), lauraceous plants (such as avocados (Persea americana), cinnamon or camphor), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), natural rubber tree, date tree, oil palm tree, ornamentals, forestry (e.g., pine, spruce, eucalyptus, poplar, conifers etc) and/or box trees.

Conifers that may be employed in practicing the embodiments are selected from pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and/or Alaska yellow-cedar (Chamaeeyparis nootkatensis).

Palm trees that may be treated are selected from Archontophoenix alexandrae (king Alexander palm), Arenga spp. (Dwarf sugar palm), Borassus flabellifer (Lontar palm), Brahea armata (blue hesper palm), Brahea edulis (Guadalupe palm), Butia capitate (pindo palm), Chamaerops humilis (European fan palm), Carpentaria spp (Carpenteria palm), Chamaedorea elegans (parlor palm), C. erupens (bamboo palm), C. seifrizii (reed palm), Chrysalidocarpus lutescens (areca palm), Coccothrinax argentata (silver palm), C. crinite (old man palm), Cocos nucifera (coconut palm), Elaeis guineensis (African oil palm), Howea forsterana (kentia palm), Livistona rotundifolia (round leaf fan palm), Neodypsis decaryi (triangle palm); Normanbya normanbi (Queensland black); Pinanga insignis; Phoenix canariensis (Canary Island date); Ptychosperma macarthuri (Macarthur palm); Rhopalostylis spp (shaving brush p.); Roystonea elata (Florida royal palm), R. regia Cuban (royal palm), Sabal spp (Cabbage/palmetto), Syagrus romanzoffiana (queen palm), Trachycarpus fortune (windmill palm), Trythrinax acanthocoma (spiny fiber palm), Washingtonia filifera (petticoat palm) and/or W. robusta (Washington/Mexican fan palm). One embodiment includes the prevention or cure of bud rot of palm trees caused, for example, by Phytophthora palmivora, Thielaviopsis paradoxa and/or bacteria. Unlike most trees, which have many points where new growth emerges, palms rely on their single terminal bud. If the terminal bud or heart becomes diseased and dies, the tree will not be able to put out any new leaf growth and will die. That is why preventative care is needed to maintain a healthy palm tree.

### Advantages

In some embodiments, the manual tip setters and manual tip setting systems described herein, and methods described herein facilitate the continuous application of liquid formulations including active ingredients to a large variety of plants, including, but not limited to, perennial plants with any kind of trunk or stem size. In some embodiments, the systems, components and methods of this disclosure enable administering active ingredients to plants at a reduced dosage rate as compared to foliar application. Reduced dosage rate is attractive because it may reduce the negative environmental impact of foliar application in which a high amount of the employed chemicals is-not reaching the target plant or pest but is release into the environmental where it may effect beneficial organism (e.g., bees) and or causes environmental pollution (e.g., ground water). And lower dosage rates may enable replacing chemical pesticides with biological control agents which are approved for human consumption but have high costs of goods which make a foliar use by spray applications in plantations of trees and other plants like banana, coffee, or cocoa punitively expensive.

In other embodiments, the manual tip setters and manual tip setting systems described herein can be used to modulate phenotypes of plants, for instance to treat, prevent, protect and immunize, which means induce local and systemic resistance to plants from pathogenic attacks and pest attacks. The injection tools described herein distribute liquid formulations directly to the interior of the plant without spraying and the commensurate loss of errantly applied sprayed formulations. The subject matter described herein places the formulations in direct contact with plant tissues and in some embodiments, the formulations are selectively administered at appropriate times to minimize (e.g., eliminate or minimize) the accumulation of chemical residues in fruits or crops as mandated.

In some embodiments, this disclosure provides methods for enhancing or maintaining plant health using the manual tip setters and manual tip setting systems described herein. In some embodiments, this disclosure provides methods for treating diseased plants and/or methods for controlling bacteria, fungi, viruses and/or other pathogens which cause disease in plants. In further such embodiments, this disclosure provides methods for treating plants whose xylem has been invaded by disease-causing bacteria, fungi, viruses, and/or other pathogens, for controlling the bacteria, fungi, virus and/or other pathogens causing the disease, and for preventing diseases by preventing sufficient colonization of the plant by the disease causing pathogens such as bacteria, fungi, and viruses.

Embodiments of the tools, systems and methods of the disclosure used with the manual tip setters and manual tip setting systems described herein may enable a systemic or directed application of active ingredients into the vascular system of a plant, such as into the stem of a plant. These embodiments can be applied to large variety of plants, included but not limited to those listed below, and may be applicable to any and all other pathogenic diseases and/or complexes that are encountered in agriculture for example in horticulture.

In some embodiments, the present disclosure relates to enhancing plant health using the manual tip setters and manual tip setting systems described herein. Healthier plants are desirable since they result among others in better yields and/or a better quality of the plants or crops, specifically better quality of the harvested plant parts. Healthier plants also better resist to biotic and/or abiotic stress. A high resistance against biotic stresses in turn allows the person skilled in the art to reduce the quantity of pesticides applied and consequently to slow down the development of resistances against the respective pesticides.

Increased yield can be characterized, among others, by the following improved properties of the plant: increased plant weight; and/or increased plant height; and/or increased biomass such as higher overall fresh weight (FW); and/or increased number of flowers per plant; and/or higher grain and/or fruit yield; and/or more tillers or side shoots (branches); and/or larger leaves; and/or increased shoot growth; and/or increased protein content; and/or increased oil content; and/or increased starch content; and/or increased pigment content; and/or increased chlorophyll content (chlorophyll content has a positive correlation with the plant's photosynthesis rate and accordingly, the higher the chlorophyll content the higher the yield of a plant), increased quality of a plant. According to the present disclosure, the yield is increased by at least 4%. In general, the yield increase may even be higher, for example 5 to 10%, for example 10 to 20%, or even 20 to 30%

Another indicator for the condition of the plant is the plant vigor. The plant vigor becomes manifest in several aspects such as the general visual appearance. Another indicator for the condition of the plant is the “quality” of a plant and/or its products and/or the plant's tolerance or resistance to biotic and/or abiotic stress factors. Biotic and abiotic stress, especially over longer terms, can have harmful effects on plants.

In some embodiments, the manual tip setters and manual tip setting systems described herein, used in combination with suitable injection tools and systems, can be used as part of a method to reduce damage of plants and/or plant parts or losses in harvested fruits or plant produce caused by phytopathogenic fungi by controlling such phytopathogenic fungi, comprising applying the tip setters and/or tip actuators in combination with the injections tools, systems, agents/formulations or methods of the disclosure to the plant. Advantageously, the disclosure is for controlling, preventing, or curing the following fungal plant diseases selected from the group: Botrytis cinerea (teleomorph: Botryotinia fuckeliana: grey mold) on fruits and berries (e.g., strawberries), rape, vines, forestry plants; Ceratocystis (syn. Ophiostoma) spp. (rot or wilt) on broad-leaved trees and evergreens, e.g., C. ulmi (Dutch elm disease) on elms; Cercospora spp. (Cercospora leaf spots) on coffee,; Colletotrichum (teleomorph: Glomerella) spp. (anthracnose) on soft fruits; Cycloconium spp., e.g., C. oleaginum on olive trees; Cylindrocarpon spp. (e.g., fruit tree canker or young vine decline, teleomorph: Nectria or Neonectria spp.) on fruit trees, vines (e.g., C. liriodendri, teleomorph: Neonectria liriodendri: Black Foot Disease) and ornamentals; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtuse; Elsinoe spp. on pome fruits (E. pyn), soft fruits (E. veneta: anthracnose) and vines (E. ampelina: anthracnose); Eutypa lata (Eutypa canker or dieback, anamorph: Cytosporina lata, syn. Libertella blepharis) on fruit trees, vines and ornamental woods; Fusarium (teleomorph: Gibberella) spp. (wilt, root or stem rot) on various plants; Glomerella cingulata on vines, pome fruits and other plants; Guignardia bidwellii (black rot) on vines; Gymnosporangium spp. on rosaceous plants and junipers, e.g., G. sabinae (rust) on pears; Hemileia spp., e.g., H. vastatrix (coffee leaf rust) on coffee; Isariopsis clavispora (syn. Cladosporium vitis) on vines; Monilinia spp., e.g., M. taxa, M. fructicola and M. fructigena (bloom and twig blight, brown rot) on stone fruits and other rosaceous plants; Mycosphaerella spp. on bananas, soft fruits, such as, e.g., M. fijiensis (black Sigatoka disease) on bananas; Phialophora spp. e.g., on vines (e.g., P. tracheiphila and P. tetraspora); Phomopsis spp. on vines (e.g., P. viticola: can and leaf spot); Phytophthora spp. (wilt, root, leaf, fruit and stem root) on various plants, such as broad-leaved trees (e.g., P. ramorum: sudden oak death); Plasmopara spp., e.g., P. viticola (grapevine downy mildew) on vines; Podosphaera spp. (powdery mildew) on rosaceous plants, hop, pome and soft fruits, e.g., P. leucotricha on apples; Pseudopezicula tracheiphila (red fire disease or rotbrenner', anamorph: Phialophora) on vines; Ramularia spp., e.g., R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g., R. solani (root and stem rot) on soybeans, R. solani (sheath blight) on rice or R. cerealis (Rhizoctonia spring blight) on wheat or barley; Rhizopus stolonifer (black mold, soft rot) on vines; Uncinula (syn. Erysiphe) necator (powdery mildew, anamorph: Oidium tuckeri) on vines; Taphrina spp., e.g., T. deformans (leaf curl disease) on peaches and T. pruni (plum pocket) on plums; Thielaviopsis spp. (black root rot) on pome fruits; Venturia spp. (scab) on apples (e.g., V. inaequalis) and pears; and/or Verticillium spp. (wilt) on various plants, such as fruits and ornamentals, vines, soft fruits.

The disclosed subject matter is employed for controlling, preventing, or curing the diseases in plants selected from:
Diseases of apple: blossom blight (Monilinia mali), powdery mildew (Podosphaera leucotricha), Alternaria leaf spot/Alternaria blotch (Alteraaria alternata apple pathotype), scab (Venturia inaequalis), bitter rot (Colletotrichum acutatum), anthrax (Colletotrieiium acutatum), decomposed disease (Valsa ceratosperma), and/or crown rot (Phytophtora cactorum);
Diseases of pear: scab (Venturia nashicola, V. pirina), black spot/purple blotch (Alternaria alternate Japanese pear pathotype). rust/frogeye (Gymnosporangium haraeanum), and/or phytophthora fruit rot (Phytophtora cactorum);
Diseases of peach: brown rot (Monilinia fructicola), black spot disease/scab (Cladosporium carpophilum), and/or phomopsis rot (Phomopsis sp.);
Diseases of grape: anthracnose (Elsinoe ampelina), powdery mildew (Uncinula necator), ripe rot (Glomerella cingulata), black rot (Guignardia bidwelli i), downy mildew (Plasmopara viticola), rust (Phakopsora ampelopsidis), and/or gray mold (Botrytis cinerea);
Diseases of Japanese persimmon: anthracnose (Gloeosporium kaki) and/or leaf spot (Cercospora kaki, Mycosphaerella nawae);
Diseases of cruciferous vegetables: Alternaria leaf spot (Alternaria japonica), white spot (Cercosporella brassicae), and/or downy mildew (Peronospora parasitica); Diseases of rapeseed: sclerotinia rot (Sclerotinia sclerotiorum) and/or gray leaf spot (Alternaria brassicae);
Diseases of rose: black spot (Diplocarpon rosae) and/or powdery mildew (Sphaerotheca pannosa);
Disease of banana: sigatoka (Mycosphaerella fijiensis, Mycosphaerella musicola, Pseudocercospora musae); and/or Colletotrichum musae, Armillaria mellea, Armillaria tabescens, Pseudomonas solanacearum, Phyllachora musicola, Mycosphaerella fijiensis, Rosellinia bunodes, Pseudomas spp., Pestalotiopsis leprogena, Cercospora hayi, Pseudomonas solanacearum, Ceratocystis paradoxa, Verticillium theobromae, Trachysphaera fructigena, Cladosporium musae, Junghuhnia vincta, Cordana johnstonii, Cordana musae, Fusarium pallidoroseum, Colletotrichum musae, Verticillium theobromae, Fusarium spp Acremonium spp., Cylindrocladium spp., Deightoniella torulosa, Nattrassia mangiferae, Dreschslera gigantean, Guignardia musae, Botryosphaeria ribis, Fusarium solani, Nectria haematococca, Fusarium oxysporum, Rhizoctonia spp., Colletotrichum musae, Uredo musae, Uromyces musae, Acrodontium simplex, Curvularia eragrostidis, Drechslera musae-sapientum, Leptosphaeria musarum, Pestalotiopsis disseminate, Ceratocystis paradoxa, Haplobasidion musae, Marasmiellus inoderma, Pseudomonas solanacearum, Radopholus similis, Lasiodiplodia theobromae, Fusarium pallidoroseum, Verticillium theobromae, Pestalotiopsis palmarum, Phaeoseptoria musae, Pyricularia grisea, Fusarium moniliforme, Gibberella fujikuroi, Erwinia carotovora, Erwinia chrysanthemi, Cylindrocarpon musae, Meloidogyne arenaria, Meloidogyne incognita, Meloidogyne javanica, Pratylenchus coffeae, Pratylenchus goodeyi, Pratylenchus brachyurus, Pratylenchus reniformia, Sclerotinia sclerotiorum, Nectria foliicola, Mycosphaerella musicola, Pseudocercosporamusae, Limacinula tenuis, Mycosphaerella musae, Helicotylenchus multicinctus, Helicotylenchus dihystera, Nigrospora sphaerica, Trachysphaera frutigena, Ramichloridium musae, Verticillium theobromae;
Disease of citrus fruits: black spot disease (Diaporthe citri), scab (Elsinoe fawcetti), and/or fruit rot (Penicillium digitatum, P. italicum);
Disease of tea: net rice disease (Exobasidium reticulatum), disease victory (Elsinoe leucospila), ring leaf spot (Pestalotiopsis sp.), anthracnose (Colletotrichum theaesinensis;
Disease of plam trees: Bud Rot, Crown Rot, Red Ring, Pudricion de Cogollo, Lethal Yellowing;
Diseases of box tree: boxwood blight fungus (Cylindrocladium buxicola also called Calonectria pseudonaviculata), Volutella buxi, Fusarium buxicola.

The methods of the disclosure can be used to reduce damage caused by a wide range of insect pests. Target insects can be selected from the order of Lepidoptera, Coleoptera, Diptera, Thysanoptera, Hymenoptera, Orthoptera, Acarina, Siphonaptera, Thysanura, Chilopoda, Dermaptera, Phthiraptera, Hemipteras, Homoptera, Isoptera and/or Aptero. Examples of such pests include, but are not limited to, Arthropods, including, for example, Lepidoptera (for example, Plutellidae, Noctuidae, Pyralidae, Tortricidae, Lyonetiidae, Carposinidae, Gelechiidae, Crambidae, Arctiidae, and/or Lymantriidae), Hemiptera (for example, Cicadellidae, Delphacidae, Psyllidae, Aphididae, Aleyrodidas, Orthezidae, Miridae, Tingidae, Pentatomidae, and/or Lygaiedae), Coleoptera (for example, Scarabaeidae, Elateridae, Coccinellidae, Cerambycidae, Chrysomelidae, and/or Curculionidae), Diptera (for example, Muscidae, Calliphoridae, Sarcophagidae, Anthomyiidae, Tephritidae, Opomyzoidea, and/or Carnoidea), Orthoptera (for example, Acrididae, Catantopidae, and Pyrgomorphidae), Thysanoptera (for example, Thripidae, Aeolothripidae, and Merothripidae), Tylenchida (for example, Aphelenchoididae and/or Neotylechidae), Collembola (for example, Onychiurus and lsotomidae), Acarina (for example, Tetranychidae, Dermanyssidae, Acaridae, and/or Sarcoptidae), Stylommatophora (for example, Philomycidae and/or Bradybaenidae), Ascaridida (for example, Ascaridida and/or Anisakidae), Opisthorchiida, Strigeidida, Blattodea (for example, Blaberidae, Cryptocercidae, and/or Panesthiidae), Thysanura (for example, Lepismatidae, Lepidotrichidae, and/or Nicoletiidae) and/or box tree moth/box tree caterpillar (Cydalima perspectalis).

The disclosure is also useful against bacterial pathogens that attack, consume (in whole or in part), or impede the growth and/or development of plants and/or act as transmission vectors to the plant and/or other plants caused by such bacterial pathogens. The bacterial pathogens can include Agrobacterium, Agrobacterium tumefaciens, Erwinia, Erwinia amylovora, Xanthomonas, Xanthomonas campestris, Pseudomonas, Pseudomonas syringae, Ralstonia solanacearum, Corynebacterium, Streptomyces, Streptomyces scabies, Actinobacteria, Micoplasmas, Spiroplasmas and/or Fitoplasmas.

The disclosure is also useful for mitigating, controlling and/or eradicating viral pathogens that attack, consume (in whole or in part), or impede the growth and/or development of the plant and/or act as transmission vectors to the plant and/or other plants caused by such viral pathogens. Such viral pathogens can include Carlaviridae, Closteroviridae, viruses that attack citrus fruits, Cucumoviridae, Ilarviridae, dwarf virus attacking prunes, Luteoviridae, Nepoviridae, Potexviridae, Potyviridae, Tobamoviridae, Caulimoviridae, as well as other viruses that attack vegetation and crops.

Plant growth-regulating compounds can be used, for example, to inhibit the vegetative growth of the plants. Such inhibition of growth is of economic interest, for example, the inhibition of the growth of herbaceous and woody plants on roadsides and in the vicinity of pipelines or overhead cables, or quite generally in areas where vigorous plant growth is unwanted. Inhibition of the vegetative plant growth may also lead to enhanced yields because the nutrients and assimilates are of more benefit to flower and fruit formation than to the vegetative parts of the plants. Frequently, growth regulators can also be used to promote vegetative growth. This is of great benefit when harvesting the vegetative plant parts. However, promoting vegetative growth may also promote generative growth in that more assimilates are formed, resulting in more or larger fruits.

Use of growth regulators can control the branching of the plants. On the one hand, by breaking apical dominance, it is possible to promote the development of side shoots, which may be highly desirable particularly in the cultivation of ornamental plants, also in combination with an inhibition of growth. On the other hand, however, it is also possible to inhibit the growth of the side shoots. This effect is of particular interest, for example, in the cultivation of tobacco or in the cultivation of tomatoes. Under the influence of growth regulators, the amount of leaves on the plants can be controlled such that defoliation of the plants is achieved at a desired time. Such defoliation plays a major role in the mechanical harvesting of cotton, but is also of interest for facilitating harvesting in other crops, for example in viticulture.

Growth regulators can also be used to achieve faster or delayed ripening of the harvested material before or after harvest. This is particularly advantageous as it allows optimal adjustment to the requirements of the market. Moreover, growth regulators in some cases can improve fruit color. In addition, growth regulators can also be used to concentrate maturation within a certain period of time. This establishes the prerequisites for complete mechanical or manual harvesting in a single operation, for example in coffee.

By using growth regulators, it is additionally possible to influence the resting of seed or buds of the plants, such that plants, including pineapple or ornamental plants in nurseries, for example, germinate, sprout or flower at a time when they are normally not inclined to do so.

Further, growth regulators can induce resistance of the plants to frost, drought or high salinity of the soil. This allows the cultivation of plants in regions which are normally unsuitable.

The compositions and/or formulations according to the disclosure also exhibit a potent strengthening effect in plants. Accordingly, they can be used for mobilizing the defences of the plant against attack by undesirable microorganisms. Plant-strengthening (resistance-inducing) substances are to be understood as meaning, in the present context, those substances which are capable of stimulating the defence system of plants in such a way that the treated plants, when subsequently inoculated with undesirable microorganisms, develop a high degree of resistance to these microorganisms. The active compounds according to the disclosure are also suitable for increasing the yield of crops. In addition, they show reduced toxicity and are well tolerated by plants.

Further, in context with the present disclosure plant physiology effects comprise the following (all of which can be modulated by the compositions, methods and devices provided herein):
Abiotic stress tolerance, comprising temperature tolerance, drought tolerance and recovery after drought stress, water use efficiency (correlating to reduced water consumption), flood tolerance, ozone stress and UV tolerance, tolerance towards chemicals like heavy metals, salts, pesticides (safener) etc.
Biotic stress tolerance, comprising increased resistance fungal diseases, increased resistance against nematodes, viruses and bacteria.
Increased plant vigor, comprising plant health, plant quality, seed vigor, reduced stand failure, improved appearance, increased recovery, improved greening effect and improved photosynthetic efficiency.

In addition, the inventive treatment can reduce the mycotoxin content in the harvested material and the foods and feeds prepared therefrom.

In another embodiment of the disclosure the tools, system, compositions/formulations and methods are employed to provide to the plant nutritional elements like nitrogen, phosphorous and potassium, as well as mineral elements, including but not limited to, silicium, calcium, magnesium and manganese.

What is claimed is:

1. A manual tip setter for installing a plant injection system into a plant part, the manual tip setter comprising:
a stationary body comprising a proximal end and a distal end;
a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part; and
a moving body positioned at the distal end of the stationary body and comprising a leadscrew coupled to the stem portion, wherein the moving body is configured to move relative to the stationary body.

2. The manual tip setter of claim 1, wherein the manual tip setter is configured to receive aa plant injection system comprising an active ingredient supply coupled to an injection tool.

3. The manual tip setter of claim 1, wherein the stem portion of the hook is configured to slide in and out of the stationary body depending on a rotation direction of the spindle.

4. The manual tip setter of claim 1, wherein the spindle is configured to receive a power source at the distal end of the stationary body, and when the power source is coupled to the spindle and in an operating mode, the spindle rotates in a first direction such that the stem portion of the hook slides into the stationary body, pulling the hooked portion of the hook closer to the stationary body.

5. The manual tip setter of claim 1, wherein, when motion of the spindle causes the hooked portion to hook around a plant part, a force of the leadscrew surpasses a force of one or more springs such that the hook stops sliding relative to the stationary body and the injection tool is installed into the plant part.

6. The manual tip setter of claim 5, wherein, when the force of the leadscrew surpasses the force of the one or more springs such that the hook stops sliding relative to the stationary body and the injection tool is installed into the plant part, the power source in operating mode causes the moving body to move towards the stationary body, pushing the active ingredient supply towards the plant part to initiate an injection process.

7. The manual tip setter of claim 6, wherein once the injection tool is installed into the plant part, the manual tip setter is configured to be removed from the pant injection system by rotating the spindle in a second direction.

8. The manual tip setter of claim 3, wherein the power source comprises an electric drill; or
wherein the power source comprises a pneumatic cylinder.

9. (canceled)

10. A manual tip setting system for installing a plant injection system into a plant part, the system comprising:
a plant injection system; and
a manual tip setter comprising:
a stationary body comprising a proximal end and a distal end;
a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part; and
a moving body positioned at the distal end of the stationary body and comprising a leadscrew coupled to the stem portion, wherein the moving body is configured to move relative to the stationary body.

11. The manual tip setting system of claim 10, wherein the manual tip setter is configured to receive the plant injection system comprising an active ingredient supply coupled to an injection tool.

12. The manual tip setting system of claim 10, wherein the stem portion of the hook is configured to slide in and out of the stationary body depending on a rotation direction of the spindle.

13. The manual tip setting system of claim 10, wherein the spindle is configured to receive a power source at the distal end of the stationary body, and when the power source is coupled to the spindle and in an operating mode, the spindle rotates in a first direction such that the stem portion of the hook slides into the stationary body, pulling the hooked portion of the hook closer to the stationary body.

14. The manual tip setting system of claim 10, wherein, when motion of the spindle causes the hooked portion to hook around a plant part, a force of the leadscrew surpasses a force of one or more springs such that the hook stops sliding relative to the stationary body and the injection tool is installed into the plant part.

15. The manual tip setting system of claim 14, wherein, when the force of the leadscrew surpasses the force of the one or more springs such that the hook stops sliding relative to the stationary body and the injection tool is installed into the plant part, the power source in operating mode causes the moving body to move towards the stationary body, pushing the active ingredient supply towards the plant part to initiate an injection process.

16. The manual tip setting system of claim 15, wherein once the injection tool is installed into the plant part, the manual tip setter is configured to be removed from the plant injection system by rotating the spindle in a second direction.

17. The manual tip setting system of claim 13, wherein the power source comprises an electric drill; or
wherein the power source comprises a pneumatic cylinder.

18. (canceled)

19. The manual tip setting system of claim 10, wherein the active ingredient supply comprises a pressurized spray can.

20. A method for installing a plant injection system into a plant using a manual tip setter having a stationary body comprising a proximal end and a distal end; a hook comprising a stem portion and a hooked portion, the stem portion located within the stationary body at the proximal end and connected to a spindle extending from the stem portion of the hook to the distal end of the stationary body, wherein and the hooked portion is configured to hook around a plant part; and a moving body positioned at the distal end of the stationary body and comprising a leadscrew coupled to the stem portion, wherein the moving body is configured to move relative to the stationary body; wherein the method comprises:
advancing the plant injection system to the plant part by moving the hooked portion, wrapped around the pant part, towards the stationary body of the manual tip setter;
installing, via the manual tip setter, the injection tool into the plant part; and
initiating, by forcing the moving body towards the stationary body, the injection process.

21. The method of claim 20, wherein advancing the plant injection system to the plant part by moving the hooked portion, wrapped around the pant part, towards the stationary body of the manual tip setter further comprises applying a power source to a power source port located at the moving body.

22. The method of claim 20, wherein initiating, by forcing the moving body towards the stationary body, the injection process, occurs when the force of the leadscrew surpasses the force of the one or more springs and causes the moving body to move towards the stationary body, pushing the active ingredient supply towards the plant part to initiate an injection process.
